(19) United States
(12) Patent Application Publication
(10) Pub. No.: US 2005/0269875 A1
(43) Pub. Date: Dec. 8, 2005

(54) Vehicle brake device

(76) Inventors: Kazuya Maki, Kariya-city (JP); Masahiro Matsuura, Kariya-city (JP); Shigeru Saito, Kariya-city (JP); Koichi Kokubo, Kariya-city (JP); Yuji Sengoku, Kariya-city (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 11/135,495

(22) Filed: May 24, 2005

(30) Foreign Application Priority Data
Jun. 8, 2004 (JP) 2004-170309
Jun. 11, 2004 (JP) 2004-174401
Sep. 30, 2004 (JP) 2004-285676
Dec. 20, 2004 (JP) 2004-367601

(51) Int. Cl. B60T 8/64

(52) U.S. Cl. 303/152

(57) ABSTRACT

A vehicle brake device is provided with a hydraulic brake device for boosting by a booster device a braking manipulation force generated upon a braking manipulation, for applying a base fluid pressure generated in dependence on the boosted brake manipulation force, to wheel cylinders of wheels so that a base hydraulic brake force is generated on the wheels, and for driving a pump to generate and apply a controlled fluid pressure to the wheel cylinders so that a controlled hydraulic brake force is generated on the wheels; braking manipulation state detecting means for detecting the braking manipulation state; a regenerative brake device for causing an electric motor to generate a regenerative brake force corresponding to the braking manipulation state on the wheels driven by the electric motor; variation detecting means for detecting the variation of an actual regenerative brake force actually generated by the regeneration braking device; and brake force compensating means for generating the controlled fluid pressure by driving the pump of the hydraulic brake device so that a controlled hydraulic brake force is generated on the wheels to compensate for the lack of the regenerative brake force due to the variation which is detected by the variation detecting means.

This application claims priorities under 35 U.S.C. 119 with respect to Japanese Applications No. 2004-170309 filed on Jun. 8, 2004, No. 2004-174401 filed on Jun. 11, 2004, No. 2004-285676 filed on Sep. 30, 2004 and No. 2004-367601 filed on Dec. 20, 2004.

### BACKGROUND OF THE INVENTION

1. Field of the Invention

The present invention relates to a vehicle brake device in which a target regenerative brake force to be applied to wheels in dependence on the braking manipulation state is attained by the sum of a hydraulic brake force of a hydraulic brake device and a regenerative brake force of a regenerative brake device.

2. Discussion of the Related Art

Heretofore, as described in Japanese unexamined, published patent application No. 2002-264795 (hereafter as Patent Document 1), there has been known a vehicle hydraulic brake device which is simplified in construction, inexpensive and suitable for use in an electric car performing a regenerative braking as well as in a motor driven car such as a so-called hybrid car provided with an electric motor as drive source. The vehicle hydraulic brake device described in Patent Document 1, as shown in FIG. 1 of the same, is provided with a fluid pressure generating device 12 for generating and outputting a predetermined fluid pressure regardless of the braking manipulation, a pressure regulating valve 16 for regulating a fluid pressure P1 supplied from the fluid pressure generating device 12 to another fluid pressure P2 depending on the braking manipulation to output the fluid pressure P2, a master cylinder 18 operable in response to the fluid pressure supplied from the pressure regulating valve 16 to an auxiliary fluid pressure chamber 19 for generating within a first master cylinder fluid pressure chamber 18e another fluid pressure P4 depending on the fluid pressure P3 within the auxiliary fluid pressure chamber 19 to supply the fluid pressure P4 from the first master cylinder fluid pressure chamber 18e, and wheel cylinders 22 to 25 responsive to the fluid pressure P4 output from the master cylinder 18 for applying a brake force to wheels of the vehicle. Solenoid proportional valves 26 and 27 are connected to a fluid pressure passage 17 which connects an output side of the pressure regulating valve 16 with the auxiliary fluid pressure chamber 19, for regulating an auxiliary fluid pressure value within the auxiliary fluid pressure chamber 19 to an arbitrary fluid pressure value which is less than an output fluid pressure value of the pressure regulating valve 16.

Further, an electric control device 13 receives information relating to the magnitude of a regenerative brake force from a drive/regeneration control electric control device (not shown) and controls the solenoid proportional valves 26 and 27 so that the reminder of subtracting the regenerative brake force from a brake force demanded by the driver becomes the brake force which is to be generated by the operations of the wheel cylinders 22 to 25. In addition, the magnitude of the regenerative brake force variously changes in dependence on the charged state of a buttery, the vehicle speed and so on. Therefore, it is most desirable that the auxiliary fluid pressure in the auxiliary fluid pressure chamber 19 can be increased or decreased to be adjustable to an arbitrary fluid pressure value.

In the vehicle hydraulic brake device described in Patent Document 1, when the regenerative brake force varies, the auxiliary fluid pressure in the auxiliary fluid pressure chamber 19 is increased or decreased in dependence on the variation to be regulated to an arbitrary fluid pressure value, and thus, it can be accomplished to apply the brake force demanded by the driver. However, it is required to provide the fluid pressure generating device 12 such as accumulators, the pressure regulating valve 16, the auxiliary fluid pressure chamber 19 and the like, and there arises a problem that the vehicle hydraulic brake device itself is still large in dimension and heavy.

Also in Japanese unexamined, published patent application No. 2001-63540 (hereafter as Patent Document 2), there is described another vehicle hydraulic brake device which is designed for securing a target brake force by properly and cooperatively controlling the distribution between the hydraulic brake force by a hydraulic brake device and the regenerative brake force by a regenerative brake device and for enhancing the energy efficiency by acquiring a sufficient regenerative power. In this Patent Document 2, the target brake force is set in dependence on the magnitude of the stepping force on a brake pedal, and the hydraulic brake device operates to generate a base hydraulic brake force in correspondence to a detected pedal stepping force. More specifically, the vehicle brake device in Patent Document 2 is provided with a booster for boosting a pedal stepping force (braking manipulation force) applied on a brake pedal, a master cylinder for generating a fluid pressure depending on the boosted force, a hydraulic brake device for supplying the fluid pressure of the master cylinder to wheel cylinders thereby to generate the brake force on wheel cylinders, and a regenerative brake device composed of an electric motor drivingly connected to the wheels and a regenerative brake force generating device for making the electric motor generate a regenerative brake force in dependence on the traveling state of the vehicle thereby to generate a brake force on the wheels connected to the electric motor. Further, in the vehicle brake device in Patent Document 2, in attaining a target brake force set in correspondence to an applied pedal steeping force, a predetermined regenerative brake force is calculated as the difference made by subtracting from the target brake force the minimum brake force of the hydraulic brake which is a base hydraulic brake force generated by the hydraulic brake device in dependence on the pedal stepping force, then a target hydraulic brake force (i.e., controlled hydraulic brake force) is calculated by subtracting from the target brake force an actual regenerative brake force which was generated by the regenerative brake force generating device in response to a command for generating the demanded regenerative brake force, and the boosting ratio of the booster device is controlled to make the hydraulic brake device generate the target hydraulic brake force in dependence on the applied pedal stepping force.

It is general that in a vehicle brake device, the boosting ratio of a booster for boosting the braking manipulation force is set to be constant and is set to be fairly large to make the hydraulic brake device take charge of a large hydraulic brake force so that when a strong brake force is required as is the case of an emergency braking against the sudden coming out of a person, a demanded vehicle brake force can be secured though the regenerative brake force cannot be secured as demanded. Thus, where the braking manipulation force is in a low range as ordinary use area, the regeneration efficiency is lowered which is the ratio of the regenerative brake force in serving for the target brake force set in dependence on the braking manipulation force, and thus, the energy efficiency has to be improved. For improvement in the energy efficiency, where an attempt is made to heighten the boosting ratio by a boosting ratio changing mechanism only upon the lack of the regenerative brake force as described in Patent Document 2, the delay in response may be felt due to a response delay of the boosting ratio changing mechanism. In addition, the booster for boosting the braking manipulation force has to be additionally provided with the boosting ratio changing mechanism, thereby making the construction complicated and the cost increased.

Further, the vehicle brake device described in the aforementioned Patent Document 2 is constructed so that a target brake force to be applied to the vehicle in dependence on the braking manipulation force is attained by the combination of a hydraulic brake force of the hydraulic brake device with a regenerative brake force of the regenerative brake device. The vehicle braked device and the method of braking the vehicle is such that in attaining the target vehicle brake force corresponding to the pedal stepping force, the minimum brake force of the hydraulic brake device corresponding to an applied pedal stepping force is subtracted from the target vehicle brake force to make the difference as an allocated brake force, that an actual brake force is subtracted from the allocated brake force to make the difference as a distributed brake force to the hydraulic brake device, and that a boosting ratio is controlled to make the target hydraulic brake force by the sum of the minimum brake force and the distributed brake force. That is, the construction is such that the brake force of the hydraulic brake device is always to work in attaining the target vehicle brake device.

However, in the vehicle brake device and vehicle brake method described in the aforementioned Patent Document 2, the brake force of the hydraulic brake device necessary works from a time point when the brake pedal begins to be stepped to another time point when the stepping is released. Thus, there is no room for the regenerative brake force to work for the target vehicle brake force, and this makes it unable to utilize the regenerative brake force positively. This gives rise to a problem that the regeneration efficiency (i.e., the ratio of the regenerative brake force to the target vehicle brake force) is deteriorated to that extent, thereby resulting in the deterioration of the vehicle fuel efficiency.

### SUMMARY OF THE INVENTION

Accordingly, it is a primary object of the present invention in one aspect to provide an improved vehicle brake device capable of being made small in dimension and light in weight and capable of making the hydraulic brake force of a hydraulic brake device compensate for the lack of the brake force due to the variation which a regenerative brake device has in its regenerative brake force.

It is an object of the present invention in another or second aspect to provide an improved vehicle brake device capable of improving the ratio of the regenerative brake force in serving for the target brake force set in dependence on the braking manipulation force even where the same is in a low range and also capable of improving the feeling about the delay of brake to work upon sudden braking.

A further object of the present invention in a third aspect is to provide an improved vehicle brake device capable of achieving a high efficiency of regeneration and a high fuel efficiency by positively utilizing a regenerative brake force in a low stepping force range which extends from a time point when the brake pedal begins to be stepped to a predetermined state.

Briefly, in a first aspect of the present invention, there is provided a vehicle brake device, which comprises a hydraulic brake device for generating by a master cylinder a base fluid pressure corresponding to a braking manipulation and for applying the generated base fluid pressure to wheel cylinders of wheels which are connected to the master cylinder through fluid passages having a fluid pressure control valve thereon so that a base hydraulic brake force is generated on the wheels, the hydraulic brake device being capable of driving a pump to generate and apply a controlled fluid pressure to the wheel cylinders so that a controlled hydraulic brake force is generated on the wheels corresponding to the wheel cylinders; and a regenerative brake device for causing any of the wheels to generate a regenerative brake force corresponding to the braking manipulation state. The vehicle brake device further comprises variation detecting means for detecting the variation of an actual regenerative brake force actually generated by the regeneration braking device, from a target regenerative brake force; and brake force compensating means for generating the controlled fluid pressure through driving the pump of the hydraulic brake device and through controlling the fluid pressure control valve so that the controlled hydraulic brake force depending on the controlled fluid pressure is generated on the wheels to compensate the lack of the regenerative brake force due to the variation which is detected by the variation detecting means.

With the construction in the first aspect of the present invention, a regeneration cooperative control can be realized by combining the hydraulic brake device which has been existent heretofore with the regenerative brake device. Thus, it can be realized to provide the vehicle brake device in which the regeneration cooperative control is possible in a simplified construction and at a low cost. Further, the controlled fluid pressure is generated through driving the pump of the hydraulic brake device and through controlling the fluid pressure control valve, so that the controlled hydraulic brake force depending on the controlled fluid pressure is generated on the wheels to compensate for the lack of the regenerative brake force due to the variation which is detected by the variation detecting means. Accordingly, since a pressure regulating means which constitutes the hydraulic brake device which has been existent heretofore is utilized as the brake force compensating means, it can be realized to stably supply the brake force demanded by the driver in a simplified construction regardless of the variation of the regenerative brake force.

In a vehicle brake device in the second aspect of the present invention, a hydraulic brake device is provided for boosting by a booster device a braking manipulation force of the driver in a predetermined boosting ratio and for generating by a master cylinder connected to the booster device a base fluid pressure corresponding to the increased braking manipulation force so that the generated base fluid pressure is applied to wheel cylinders of wheels which are connected to the master cylinder through fluid passages having a fluid pressure control valve thereon to make the wheels generate a base hydraulic brake force. The hydraulic brake device is capable of driving a pump to generate and apply a controlled fluid pressure to the wheel cylinders so that a controlled hydraulic brake force is generated on the wheels corresponding to the wheel cylinders. The vehicle brake device is further provided with a regenerative brake device for causing any of the wheels to generate a predetermined regenerative brake force when having the braking manipulation force input so that the predetermined regenerative brake force and the generated base hydraulic brake force attains a target brake force corresponding to the braking manipulation force; variation detecting means for detecting the variation of an actual regenerative brake force actually generated by the regenerative brake device, from the predetermined regenerative brake force; and brake force compensating means operable when the variation is detected by the variation detecting means, for generating the controlled fluid pressure through driving the pump of the hydraulic brake device and through controlling the fluid pressure control valve so that a controlled hydraulic brake force depending on the controlled fluid pressure is generated on the wheels to compensate for the lack of the regenerative brake force due to the detected variation. The booster device has a boosting property that the boosting ratio is low when the braking manipulation force is in a low range but becomes high when the braking manipulation force exceeds the low range.

With the construction in the second aspect of the present invention, a regeneration cooperative control can be realized by combining the hydraulic brake device which has been existent heretofore with the regenerative brake device. Further, when the regenerative brake force varies, the variation detecting means detects the variation of the regenerative brake force which has been actually generated by the regenerative brake device, and the brake force compensating means compensates for the lack of the brake force which is due to the variation of the regenerative brake force detected by the variation detecting means, by causing the wheels to generate the controlled hydraulic brake force through driving the pump of the hydraulic brake device and through controlling the fluid pressure control valve. At this time, since the boosting ratio of the booster device is low where the braking manipulation force is in the low range, the ratio of the regenerative brake force is heightened in sharing the target brake force which is to be generated on the wheels in dependence on the braking manipulation force, and thus, the energy efficiency can be improved. Where the braking manipulation force exceeds the low range, the boosting ratio of the booster device is heightened to raise the increase rate of the base fluid pressure supplied from the master cylinder to the wheel cylinders. Thus, it can be realized that the wheels are quickly caused to generate the controlled hydraulic brake force to compensate for the lack of the regenerative brake force which is due to the detected variation.

In a third aspect of the present invention, there is provided a vehicle brake device, which comprises a hydraulic brake device for generating by a master cylinder a base fluid pressure corresponding to a braking manipulation state that a brake pedal is stepped in and for applying the generated base fluid pressure directly to wheel cylinders of wheels which are connected to the master cylinder through fluid passages having a fluid pressure control valve thereon so that a base hydraulic brake force corresponding to the base fluid pressure is generated on the wheels. The vehicle brake device further comprises a regenerative brake device for causing any of the wheels to generate a regenerative brake force corresponding to the braking manipulation state. The vehicle brake device is capable of cooperatively operating the hydraulic brake device and the regeneration bake device for applying to the vehicle a vehicle brake force corresponding to the braking manipulation state based on the base hydraulic brake force and the regenerative brake force. The vehicle brake device further comprises base hydraulic brake force generation restricting means for restricting the generation of the base hydraulic brake force to a predetermined value or less until the braking manipulation state is varied from a stepping-in starting state which is the state at the time point of the stepping-in start to a predetermined state.

With the construction in the third aspect of the present invention, upon stepping on the brake pedal, the base hydraulic brake force generation restricting means restricts the generation of the base hydraulic brake force to the predetermined value or less until the braking manipulation state is varied from the stepping-in starting state which is the state at the time point of the stepping-in start to the predetermined state. Thus, when the driver steps on the brake pedal, the base hydraulic brake force is compulsorily restricted to the predetermined value or less from the stepping-in starting state until the predetermined state is reached. During this period, on the other hand, the regenerative brake device uses its regenerative brake force to compensate for the lack of the base hydraulic brake force in the vehicle brake force through the cooperative operation with the hydraulic brake device in attaining the vehicle brake force corresponding to the braking manipulation state. Accordingly, in the low stepping force range extending from the stepping-in starting state until the predetermined state is reached, the regenerative brake force is positively utilized, so that it can be realized to achieve a high regeneration efficiency and hence, a high fuel efficiency.

### BRIEF DESCRIPTION OF THE ACCOMPANYING DRAWINGS

The foregoing and other objects and many of the attendant advantages of the present invention may readily be appreciated as the same becomes better understood by reference to the preferred embodiments of the present invention when considered in connection with the accompanying drawings, wherein like reference numerals designate the same or corresponding parts throughout several views, and in which:

FIG. 1 is a system diagram of a vehicle brake device in a first embodiment according to the present invention;

FIG. 2 is a diagram showing a hydraulic brake device shown in FIG. 1;

FIG. 3 is a flow chart of a control program executed by a brake ECU shown in FIG. 1;

FIG. 4 is a graph showing a correlation between braking manipulation force and vehicle deceleration speed under a regeneration cooperative control;

FIG. 5 is a graph showing the configuration of brake force upon the variation of regenerative brake force;

FIG. 6 is a graph showing an ideal brake force distribution curve and a correlation between hydraulic brake force and regenerative brake force;

FIG. 7 is a combination of graphs showing the correlation at the switching of the regenerative brake force with the hydraulic brake force;

FIG. 8 is another combination of graphs showing the correlation at the switching of the regenerative brake force with the hydraulic brake force;

FIG. 9 is a graph showing the correlation at the switching of the regenerative brake force with the hydraulic brake force;

FIG. 10 is a flow chart of a control program executed by a brake ECU in a second embodiment according to the present invention;

FIG. 11 is a graph showing a correlation of braking manipulation force with base fluid pressure in a third embodiment according to the present invention;

FIG. 12 is a flow chart of a cooperative control program executed by a brake ECU in the third embodiment;

FIG. 13 is a graph showing a correlation of braking manipulation force with output of a booster device in the third embodiment;

FIG. 14 is a graph showing another correlation of the braking manipulation force with the output of the booster device in the third embodiment;

FIG. 15 is a system diagram of a vehicle brake device in a fourth embodiment according to the present invention;

FIG. 16 is a side elevational view partly in section of a base hydraulic brake generation device in a state prior to the stepping of a brake pedal;

FIG. 17 is another side elevational view partly in section of the base hydraulic brake generation device upon the stepping of the brake pedal;

FIG. 18 is a schematic diagram showing a hydraulic brake device shown in FIG. 15;

FIG. 19 is a graph showing a correlation of braking manipulation force with brake force in the fourth embodiment;

FIG. 20 is a sectional view of a pressure regulating reservoir shown in FIG. 18 in the state that the brake pedal is not stepped;

FIG. 21 is another sectional view of the pressure regulating reservoir in the state that the brake pedal is being stepped in;

FIG. 22 is a flow chart of a control program executed by a brake ECU shown in FIG. 15;

FIG. 23 is a sectional view of a pressure regulating reservoir in a fifth embodiment of a vehicle brake device according to the present invention;

FIG. 24 is a graph showing a correlation of braking manipulation force with brake force in the fifth embodiment;

FIG. 25 is a sectional view of an operating rod in a state prior to the stepping, of a brake pedal of a vehicle brake device in a sixth embodiment according to the present invention; and

FIG. 26 is a modified form of pedal reaction force applying means shown in FIG. 16.

### DETAILED DESCRIPTION OF THE PREFERRED EMBODIMENTS

### First Embodiment

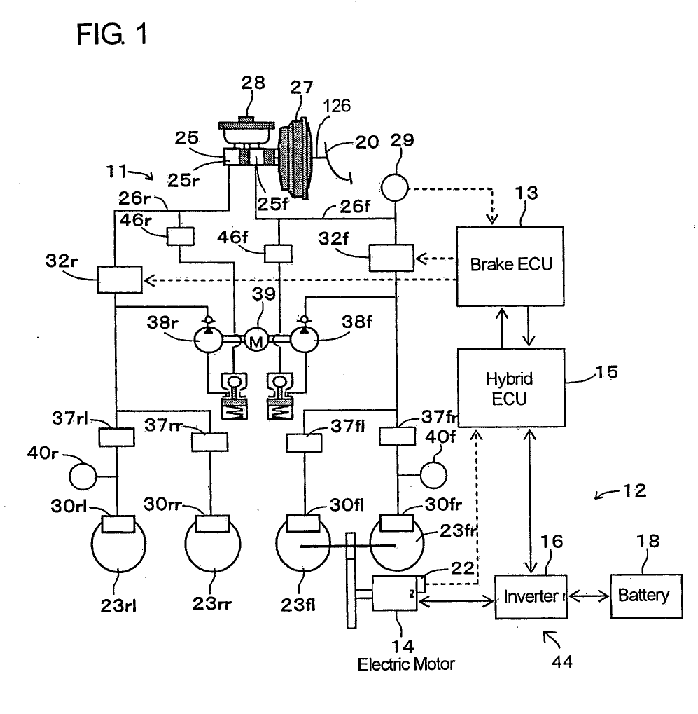

A vehicle brake device in a first embodiment according to the present invention will be described hereinafter with reference to the accompanying drawings. As shown in FIG. 1, the vehicle brake device is constructed to be applied to a front-drive motor driven car and is provided with a hydraulic brake device 11, a regenerative brake device 12, a brake ECU 13 for cooperatively controlling these devices 11 and 12, and a hybrid ECU 15 for controlling an electric motor 14 which is the drive power source for the motor driven car, through an inverter 16 in dependence on a demand value from the brake ECU 13.

The hydraulic brake device 11 is capable of applying a base hydraulic brake force to each of the wheels 23 by causing a vacuum booster 27 as a booster device to increase the braking manipulation force which is generated by the braking manipulation or the stepping manipulation on a brake pedal 20 and by applying a base fluid pressure depending on the increased braking manipulation force, to wheel cylinders 30 of the wheels 23. The hydraulic brake device 11 is also capable of applying to the wheel cylinders 30 a controlled fluid pressure which is generated by driving hydraulic pumps 38 regardless of the braking manipulation, thereby to generate a controlled hydraulic brake force to the wheels 23 corresponding to the wheel cylinders 30. The regenerative brake device 12 is for causing an electric motor 22 which drives some of the wheels 23, to generate on some such wheels a regenerative brake force which corresponds to the braking manipulation state which is detected by a fluid pressure sensor (master cylinder pressure sensor) 29 as braking manipulation state detecting means for detecting the brake manipulation state.

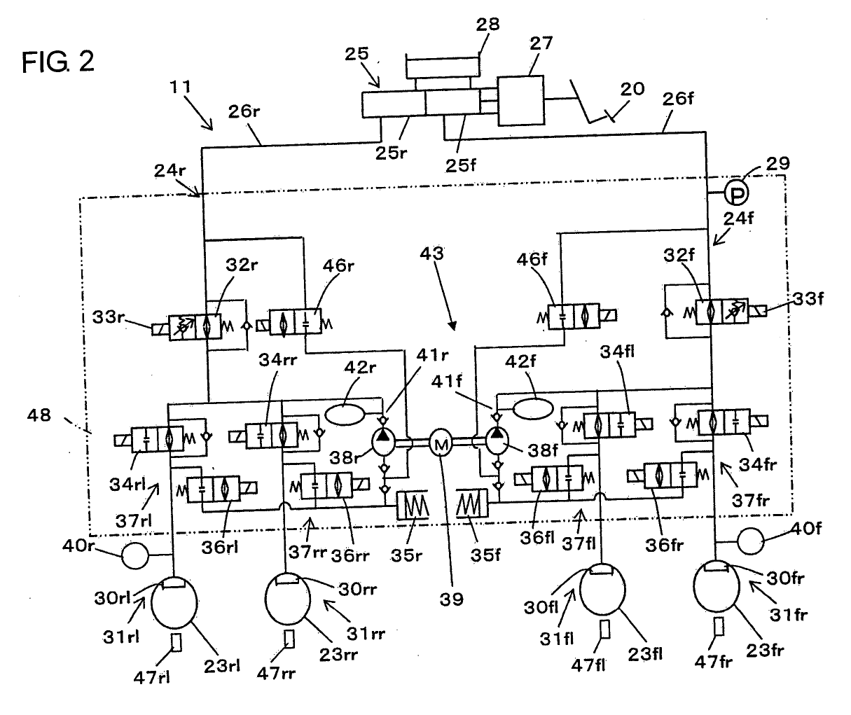

In the hydraulic brake device 11, as shown in FIG. 2, a front brake system 24f and a rear brake system 24r which take almost the same construction are provided separately for respectively applying brake forces to front left and right wheels 23fl, 23fr and rear left and right wheels 23rl, 23rr when the brake pedal 20 is stepped in by the driver. In FIG. 2, the components for the front wheels 23fl, 23fr and those for the rear wheels 23rl, 23rr are identical in construction and operation, and thus, the parts identical in construction and operation are distinguished by being designated by reference symbols which have the same reference numerals with different suffixes “f” and “r”, respectively. Further, to distinguish the components for the left wheels from those the right wheels, the parts identical in construction and operation are distinguished by having second suffixes “l” and “r” following the suffixes “f” and “r” which distinguish the components for the front wheels from those for the rear wheels. Herein, where the components are referred to without distinction among the front, rear, left and right wheels, only reference numerals are given to the components.

A numeral 25 designates a dual type master cylinder, which feeds brake oil of the fluid pressure corresponding to a pedal stepping force from fluid pressure chambers 25f, 25r to conduits (fluid passages) 26f, 26r when the brake pedal 20 is stepped. A numeral 27 designates a vacuum booster as a booster device which is interposed between an operating rod 126 axially movable by the brake pedal 20 in the forward-rearward direction and a piston rod of the master cylinder 25. The vacuum booster 27 boosts (increases) the pedal stepping force acting on the brake pedal 20 by applying the intake vacuum for an engine to a diaphragm incorporated therein. A numeral 28 designates a reservoir storing the brake fluid, and the reservoir 28 replenishes the brake oil to the master cylinder 25.

The master cylinder 25 generates a base fluid pressure depending on the force increased by the vacuum booster 27. The base fluid pressure sent out from the master cylinder 25 is supplied to the left and right wheel cylinders 30fl, 30fr, 30rl and 30rr through the conduits 26f, 26r, whereby friction members of brake means 31 are operated to apply a base hydraulic brake force to the front left and right wheels 23fl, 23fr and the rear left and right wheels 23rl, 23rr. The brake means 31 can be constituted by disc brakes, drum brakes or the like and applies a brake force to each wheel by causing the friction member such as brake pad, brake shoe or the like to restrict the rotation of a disc rotor, a brake drum or the like which is bodily provided on each wheel.

Solenoid fluid pressure proportional control valves 32f, 32r which constitute fluid pressure control valves as brake force compensating means are provided respectively for the front and rear brake systems 24f, 24r and are connected at inlet ports thereof to the fluid pressure chambers 25f, 25r of the master cylinder 25 through the conduits 26f, 26r, respectively. Each solenoid fluid pressure proportional control valve 32 operates for pressure control so that the fluid pressure at an outlet port thereof becomes higher in a range of zero to a control pressure difference than the fluid pressure at the inlet port in dependence on a control current applied to a linear solenoid 33 thereof. In the case of ordinary control, the solenoid fluid pressure proportional control valve 32 is shifted to an open position upon energization of the linear solenoid 33 to make the inlet port and the outlet port communicate directly. A check valve for allowing the fluid flow from the inlet port to the outlet port is connected between the inlet port and the outlet port of each of the solenoid fluid pressure proportional control valves 32f, 32r in parallel with the same.

The conduit 26f has connected thereon the fluid pressure sensor 29 between the fluid pressure chamber 25f and the solenoid fluid pressure proportional control valve 32f, and the fluid pressure sensor 29 detects the fluid pressure (master cylinder pressure) sent out from the master cylinder 25 to transmit the detected pressure to the brake ECU 13. Since the master cylinder pressure represents the braking manipulation state, the fluid pressure sensor 29 constitutes braking manipulation state detecting means.

The conduits 26f, 26r connected to the respective outlet ports of the solenoid fluid pressure proportional control valves 32f, 32r are branched therefrom to be connected to the front left and right wheel cylinders 30fl, 30fr and the rear left and right wheel cylinders 30rl, 30rr through solenoid shut-off valves 34fl, 34fr, 34rl and 34rr, respectively. Each of the solenoid shut-off valves 34fl, 34fr, 34rl and 34rr has a check valve connected in parallel therewith between inlet and outlet ports thereof for allowing the fluid flow from the outlet port to the inlet port. Solenoid shut-off valves 36fl, 36fr, 36rl and 36rr are connected between the respective outlet ports of the solenoid shut-off valves 34fl, 34fr, 34rl, 34rr and reservoirs 35f, 35r, respectively. Each of the reservoirs 35f, 35r takes the construction that a piston urged by a compression spring is slidably and fluid-tightly received in a bottomed casing. The solenoid shut-off valves 34 and 36 constitute ABS control valves 37 each of which controls pressure increase, pressure retention and pressure reduction within the associated wheel cylinder 30.

Fluid pressure sensors 40f and 40r as brake force detecting means are respectively connected downstream of the ABS control valves 37f, 37r for the front and rear brake systems 24f, 24r. Although an existent brake actuator 48 is constructed to pack within one case the solenoid fluid pressure proportional control valves 32, the ABS control valves 37f, 37r, the reservoirs 35, the hydraulic pumps 38, an electric motor 39 and the like, the fluid pressure sensors 40f and 40r are respectively connected downstream of the ABS control valves 37f, 37r for the front and rear brake systems 24f, 24r and thus, can be connected outside of the brake actuator 48 to conduits which connect the outlet ports of the ABS control valves 37f, 37r respectively to the wheel cylinders 30fr, 30fl, to be close to the same, respectively. Thus, it can be realized to connect the fluid pressure sensors 40f and 40r simply and at a low cost without altering the brake actuator 48 being versatile. In this case, since it does not occur that the cooperative control between the hydraulic brake device 11 and the regenerative brake device 12 is executed simultaneously with an anti-lock brake control, it does not take place that the ABS control valves 37f, 37r are opened and closed under the cooperative control, so that it can be realized to supply required fluid pressure to the respective wheel cylinders 30f, 30r accurately by performing the feedback controls of the solenoid fluid pressure proportional control valves 32f, 32r based on the detection signals of the fluid pressure sensors 40f and 40r which are connected downstream of the ABS control valves 37f, 37r closely to the wheel cylinders 30fr, 30rl. Although there cannot be expected an advantage that the fluid pressure sensors 40f and 40r can be connected simply without altering the versatile brake actuator 48, the fluid pressure sensors 40f and 40r may be connected between the solenoid fluid pressure proportional control valves 32f, 32r and the ABS control valves 37f, 37r, respectively.

The pumps 38f, 38r constituting a fluid pressure generating device is driven by the motor 39. The outlet ports of the pumps 38 are connected to intermediate portions between the outlet ports of the solenoid fluid pressure proportional control valves 32f, 32r and the inlet ports of the ABS control valves 37f, 37r through check valves 41f, 41r which block the fluid flows toward the outlet ports of the pumps 38, respectively. The inlet ports of the pumps 38 are connected to the inlet ports of the solenoid fluid pressure proportional control valves 32f, 32r through solenoid shut-off valves 46f, 46r and are further connected to intermediate portions between the outlet ports of the solenoid shut-off valves 36f, 36r of the ABS control valves 37f, 37r and the reservoirs 35f, 35r, respectively. Reference numerals 42f, 42r denote dampers for absorbing the pulsations in the fluid pressures discharged from the pumps 38f, 38r.

The aforementioned pumps 38, motor 39, solenoid fluid pressure proportional control valves 32 and the like constitute a controlled hydraulic brake force applying device 43, which causes the fluid pressure control valves to regulate the fluid pressures supplied from the fluid pressure generating device (i.e., pumps 38) to the wheel cylinders 30 in dependence on the traveling state of the vehicle thereby to generate control fluid pressures and which applies the controlled fluid pressures to the wheel cylinders 30 thereby to generate a controlled hydraulic brake force on each wheel 23. The controlled hydraulic brake force applying device 43 are provided with solenoid fluid pressure proportional control valves 32f, 32r as fluid pressure control valves for the plural separated systems and supply the controlled fluid pressures regulated by the solenoid fluid pressure proportional control valves 32f, 32r to the wheel cylinders 30f, 30r. The solenoid fluid pressure proportional control valves 32 constitute brake force compensating means which generates the controlled fluid pressures through driving the pumps 38 of the hydraulic brake device 11 for applying the controlled hydraulic brake forces to the wheels 23 to compensate for the lack of the brake force due to the variation in the regenerative brake force which is detected by variation detecting means (referred to later). The brake force compensating means is preferable to be provided for each of the front and rear systems of the vehicle having the brake systems for the front and rear systems 24 and is further preferable to be able to be regulated in pressure for ideal brake force allocation or distribution.

The hydraulic brake device 11 is composed of the booster device 27 for increasing the stepping force, the master cylinder 25 for generating the base fluid pressure corresponding to the increased force, the brake means 31 for enabling the base fluid pressure of the master cylinder 25 to be supplied to the wheel cylinders 30 thereby to apply the base hydraulic brake force to each wheel 23, and the controlled hydraulic brake force applying device 43 for controlling, by the solenoid fluid pressure proportional control valves 32, the fluid pressures supplied from the pumps 38 to the wheel cylinders 30 in dependence on the traveling state of the vehicle thereby to cause the bake means 31 to generate the controlled brake force. Further, the brake actuator 48 is constructed to pack within one case the components encircled by the phantom line in FIG. 2 including the controlled hydraulic brake force applying device 43, the ABS control valves 37, the reservoirs 35 and the like. This brake actuator 48 is one which has already been existent.

The aforementioned hydraulic brake device 11 is capable of executing the following traction control, brake assist control, slope starting control, active cruise control and the like. The traction control is the control for enabling the brake means to apply slip-dependent hydraulic brake forces to the wheels. This control can be done by supplying fluid pressures from the fluid pressure generating device (i.e., pumps 38) to the wheel cylinders of drive wheels (e.g., the front wheels 23f in the present embodiment) to control the fluid pressures by the fluid pressure control valves in dependence on slip amounts when the slip amount of each drive wheel exceeds a predetermined value and further increases, by stopping the fluid pressure generating device to retain the pressures, which are controlled by the fluid pressure control valves in dependence on the slip amounts, in the wheel cylinders of the drive wheels when the slip amount of each drive wheel exceeds the predetermined value but does not further increase, and by connecting the wheel cylinders of the drive wheels to the reservoirs when the slip amount of each drive wheel is less than the predetermined value.

The brake assist control is the control for enabling the brake means to apply large hydraulic brake forces to the wheels when sudden braking is to be applied or when strong brake force is to be generated. This can be done by supplying the fluid pressures from the fluid pressure generating device (i.e., pumps 38) to the wheel cylinders and then by causing the fluid pressure control valves to control the fluid pressures to higher fluid pressures than those supplied from the master cylinder.

The slope starting control is the control for enabling the brake means to apply to the wheels hydraulic brake forces which keep the vehicle stopped on a slope upon starting on the slope. This can be done by supplying fluid pressures from the fluid pressure generating device (i.e., pumps 38) to the wheel cylinders of the drive wheels and by causing the fluid pressure control valves to control the fluid pressures to stop retention pressures.

The active cruise control is the control for enabling the brake means to automatically apply hydraulic brake forces to the wheels when the distance from a car ahead becomes less than a predetermined value. This control can be done by supplying the fluid pressures from the fluid pressure generating device (i.e., pumps 38) to the wheel cylinders of the drive wheels and then by causing the fluid pressure control valves to control the fluid pressures so that the distance from the car ahead can be kept to be more than the predetermined value.

Further, the vehicle brake device is provided with the fluid pressure sensor 29, the solenoid fluid pressure proportional control valves 32, the solenoid shut-off valves 34, 36 and 46, the motor 39 and the brake ECU (Electronic Control Unit) 13 having connected thereto wheel speed sensors 47 for detecting the wheel speeds of the wheels 23. The brake ECU 13 executes the switching controls or the current control of the open/close motions of the respective valves 34, 36 and 46 in the hydraulic brake device 11 in dependence on the detection signals of the respective sensors and the state of a shift switch (not shown) for controlling the controlled fluid pressures to be applied to the wheel cylinders 30, that is, the controlled hydraulic brake forces to be applied to the respective wheels 23fl, 23fr, 23rl, 23rr.

Further, the brake ECU 13 is connected with the hybrid ECU 15 for mutual communication therebetween, wherein a cooperative control between the regenerative braking performed by the electric motor 14 and the hydraulic braking is performed to make a total brake force of the vehicle equivalent to that of the vehicle which attains the total brake force by the hydraulic brake only. More specifically, the brake ECU 13 is responsive to the brake demand of the driver or to the braking manipulation state and outputs to the hybrid ECU 15 a regeneration demand value which of the total brake force, is the portion to be undertaken by the regenerative brake device 12, as a target value for the regenerative brake device 12, namely, as a target regenerative brake force. The hybrid ECU 15 derives an actual regeneration execution value to be actually applied as the regenerative brake force, based on the regeneration demand value (target regenerative brake force) input thereto and also taking into account of the vehicle speed, the charged state of a battery 18, and the like. The hybrid ECU 15 then controls through the inverter 16 the electric motor 14 to generate the regenerative brake force corresponding to the actual regeneration execution value and also outputs the derived actual regeneration execution value to the brake ECU 13.

Further, the brake ECU 13 stores various base hydraulic brake forces which the brake means 31 selectively applies to the wheels 23 when a base fluid pressure is supplied to the wheel cylinder 30, in a memory in the form of a map, table or arithmetic expression. Also, the brake ECU 13 stores various target regenerative brake forces which are to be selectively applied to the wheels 23 independence on the braking manipulation state found from the master cylinder pressure, in the memory in the form of another map, table or arithmetic expression.

Referring now again to FIG. 1, the regenerative brake device 12 is composed of the electric motor 14 for driving the front wheels 23f, the inverter 16 electrically connected to the electric motor 14, the battery 18 as direct current power supply electrically connected to the inverter 16. The inverter 16 converts the direct current power of the battery 18 to an alternate current power in dependence on control signals supplied from the hybrid ECU 15 to supply the converted alternate current power to the electric motor 14 and also converts the alternate current power generated by the electric motor 14 into a direct current power to charge the battery 18 therewith.

The hybrid ECU 15 and the inverter 16 are connected and are able to communicate with each other. The hybrid ECU 15 has also connected thereto an accelerator sensor (not shown) which is incorporated in an accelerator for detecting the opening degree of the accelerator, and has an accelerator opening degree signal input from the accelerator. The hybrid ECU 15 has also connected to a rotation sensor (not shown) which is incorporated in the electric motor 14 for detecting the rotational speed of the electric motor 14 and has a rational speed signal input therefrom. The hybrid ECU 15 derives a required motor torque from the accelerator opening degree signal (referred to later) and the shift position (calculated from a shift position signal input from the shift position sensor, not shown) and controls the motor 14 through the inverter 16 in dependence on the required value of the motor torque so derived. Further, the hybrid ECU 15 watches the charged state and charged current of the battery 18.

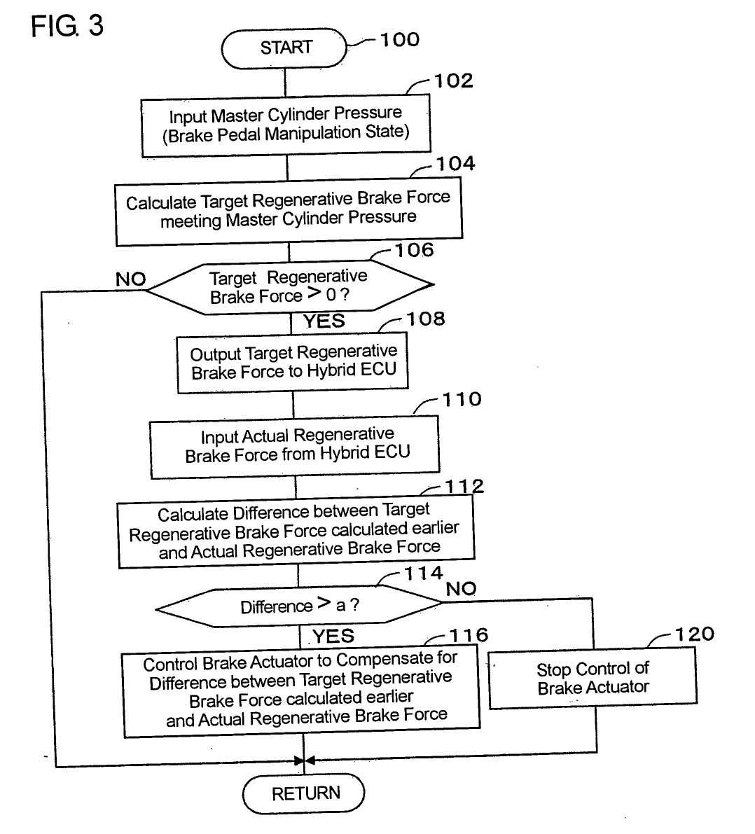

Next, the operation of the vehicle brake device as constructed above will be described in accordance with a flow chart shown in FIG. 3. The brake ECU 13 executes a program corresponding to the flow chart at a predetermined minute time interval when an ignition switch (not shown) of the vehicle is in ON state. The brake ECU 13 takes thereinto the master cylinder pressure representing the manipulating state of the brake pedal 20, from the fluid pressure sensor 29 (step 102) and calculates a target regenerative brake force corresponding to the input master cylinder pressure (step 104: target regenerative brake force calculating means). At this time, the brake ECU 13 uses the map, table or arithmetic expression which has been stored in advance for showing the correlation between the master cylinder pressure or the brake manipulating state and the target regenerative brake force to be applied to the wheels.

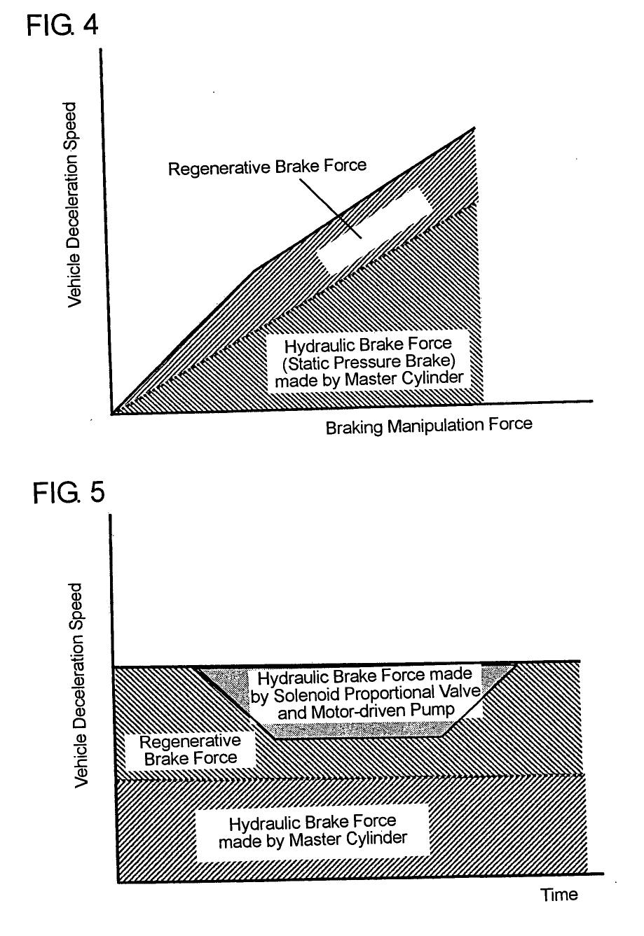

When the target regenerative brake force is larger than zero, the brake ECU 13 outputs the target regenerative brake force calculated at step 104 to the hybrid ECU 15 and does not execute the control of the controlled hydraulic brake force applying device 43 (steps 106 and 108). Thus, when the brake pedal 20 is being stepped on, as is the aforementioned case, the hydraulic brake device 11 applies the base hydraulic brake forces (static pressure brakes) only to the wheels 23f, 23r. Further, the hydraulic ECU 15 has input thereto a regeneration demand value representing the target regenerative brake force, controls the electric motor 14 through the inverter 16 so that the regenerative brake force can be generated based on the regeneration demand value and taking the vehicle speed and the charged state of the battery 18 into consideration, and outputs the actual regeneration execution value to the brake ECU 13. Accordingly, when the braking manipulation is being performed and when the target regenerative brake force is larger than zero, the regenerative brake force together with the base hydraulic brake force is additionally applied to the front wheels 23fl, 23fr. Although the regeneration cooperative control is executed in this manner, the base hydraulic brake force and the regenerative brake force are in dependence on the braking manipulation force, and one example for this dependence is shown in FIG. 4. FIG. 4 shows the correlation in which the sum of the base hydraulic brake force and the regenerative brake force is indicated in connection with the braking manipulation force under the regeneration cooperative control and the vehicle deceleration speed.

The brake ECU 13 detects the variation in the regenerative brake force which is actually generated by the regenerative brake device 12 (steps 110 to 114). Specifically, the brake ECU 13 at step 110 inputs therein the actual regeneration execution value indicating the actual regenerative brake force which the regenerative brake device 12 actually applied to the front wheels 23f in response to the target regenerative brake force calculated at step 104 (step 110: actual regenerative brake force inputting means), calculates a difference between the target regenerative brake force calculated at step 104 and the actual regenerative brake force input at step 110 (step 112: difference calculating means), and detects the occurrence of the variation in the regenerative brake force if the calculated difference is larger than a predetermined value (a) (step 114: judgment means). The processing at steps 104 and 110 to 114 constitutes variation detecting means (or variation processing method) for detecting the variation in the regenerative brake force which has been actually generated by the regenerative brake device 12. The variation detecting means as a device is constituted by the brake ECU 13.

Then, when detecting the variation in the regenerative brake force, the brake ECU 13 makes a judgment of YES at step 114 and compensates for the lack of the brake force due to the variation in the regenerative brake force detected by the variation detecting means by generating the controlled fluid pressures while driving the pumps 38 of the hydraulic brake device 11 and by applying controlled hydraulic brake forces to the wheels 23 (step 116). Specifically, the brake ECU 13 controls the controlled fluid pressures generated by the controlled hydraulic brake force applying device 43 so that the controlled fluid pressures coincide with the difference between the target regenerative brake force calculated at step 104 and the actual regenerative brake force input at step 110, that is, with the difference calculated at step 112. The brake ECU 13 starts the electric motor 39 to drive the pumps 38 and applies an electric current to the linear solenoids 33 of the solenoid fluid pressure proportional control valves 32 so that the fluid pressures of the brake fluids supplied from the pumps 38 to the wheels cylinders 30 become the controlled fluid pressures. At this time, it is preferable to perform a feedback control on the linear solenoids so that the fluid pressures in the wheel cylinders 30 detected by the fluid pressure sensors 40 coincide with the controlled fluid pressures. Thus, the fluid pressures are supplied from the pumps 38 to the wheel cylinders 30, and the fluid pressures are controlled by the solenoid fluid pressure proportional control valves 32 to the controlled fluid pressures. The hydraulic brake device 11 applies to the wheels 23 the controlled fluid pressures each of which is the difference between the target regenerative brake force and the actual regenerative brake force. One example of the manner of controlling the controlled fluid pressure is shown in FIG. 5, wherein the correlation is represented between the time and the vehicle deceleration speed during the variation in the regenerative brake force. From this figure, it can be understood that the controlled hydraulic brake force is given to compensate for that portion by which the regenerative brake force is decreased, namely, that portion by which the regenerative brake force is decreased from the target regenerative brake force.

When not detecting the variation in the regenerative brake force, on the other hand, the brake ECU 13 makes a judgment of NO at step 114 and stops controlling the controlled hydraulic brake force applying device 43 (step 120).

As is clear from the foregoing description, the regeneration cooperative control can be realized by combining the heretofore existent hydraulic brake device 11 and the regenerative brake device 12. Thus, it can be realized to provide the vehicle brake device in which the regeneration cooperative control is possible in a simplified construction and at a low cost. Further, when the regenerative brake force varies, the brake ECU 13 detects the variation in the regenerative brake force which has been actually generated by the regenerative brake device 12, from the target regenerative brake force. When the variation is detected, the brake ECU 13 generates the controlled fluid pressures by driving the pumps 38 of the hydraulic brake device 11 and by controlling the solenoid fluid pressure proportional control valves 32, whereby the controlled hydraulic brake forces in dependence on the controlled fluid pressures are generated on the wheels to compensate for the lack of the regenerative brake force due to the detected variation. Accordingly, since the solenoid fluid pressure proportional control valves 32 as the pressure regulating means which constitutes the heretofore existent hydraulic brake device 11 is utilized as the brake force compensating means, it can be realized to stably supply the brake force demanded by the driver in the simplified construction regardless of the variation in the regenerative brake force.

Further, the hydraulic brake device 11 has connected thereto the booster device 27 for boosting the braking manipulation force to the master cylinder 25, and the master cylinder 25 operates to generate the base fluid pressures corresponding to the force boosted by the booster device 27. Thus, it is possible to utilize the hydraulic brake device 11 which has been wide spread heretofore and which is reliable and inexpensive. In addition, the booster device 27 can take a simplified construction as being the vacuum booster device.

Furthermore, in the present embodiment, the regenerative brake force in FIG. 4 is determined in dependence on the generation capability, to correspond to, e.g., its maximum regeneration capability. That is, where the regenerative brake force is too high at the distribution or responsibility ratio, a large burden is imposed on the pumps 38 of the controlled hydraulic brake force applying device 43 in attaining the target brake force, and this results in deterioration of the feeling given during braking. Conversely, where the regenerative brake force is low at the responsibility ratio, the regenerative brake force has an extra or surplus which cannot be utilized, and this results in deterioration of the regeneration efficiency. On the other hand, as described above, where the responsibility ratio of the regenerative brake force is determined in dependence on the generation capability or the maximum regeneration capability, the regeneration efficiency can be heightened, and the feeling can be improved owing to the reduction of the burden on the pumps 38. Where the required regeneration capability differs in dependence on the car model, the responsibility ratio for the regenerative brake force is adapted for the generation capability for the car model, so that the foregoing advantages can be accomplished in each of the respective car models.

Also in the vehicle with the brake systems for the front and rear systems, the regeneration cooperative control can be realized by combining the heretofore existent hydraulic brake device 11 and the regenerative brake device 12. Thus, it can be realized to provide the vehicle brake device in which the regeneration cooperative control is possible in the simplified construction and at the low cost. The brake ECU 13 detects the variation in the regenerative brake force which has been actually generated by the regenerative brake device 12, from the target regenerative brake force, determines the predetermined front-rear brake force distribution for the front and rear systems, and detects the brake forces generated on the respective wheels of the front and rear systems. Where the detected brake forces lack in terms of the determined front-rear brake force distribution, the brake ECU 13 generates a controlled fluid pressure by driving the pumps 38 of the hydraulic brake device 11 and by controlling the solenoid fluid pressure proportional control valves 32, whereby the controlled hydraulic brake forces in dependence on the controlled fluid pressures are generated on the wheels to compensate for the lack in terms of the front-rear brake force distribution. Accordingly, with a simplified construction and regardless of the variation in the regenerative brake force, it can be realized to stably apply the brake forces required by the driver to both of the front and rear systems. Additionally, by controlling the solenoid fluid pressure proportional control valves 32 which are respectively provided in the front and rear systems of the vehicle having the brake systems for the front and rear systems, it can be realized to control the brake forces for the both of the front and rear systems independently and reliably.

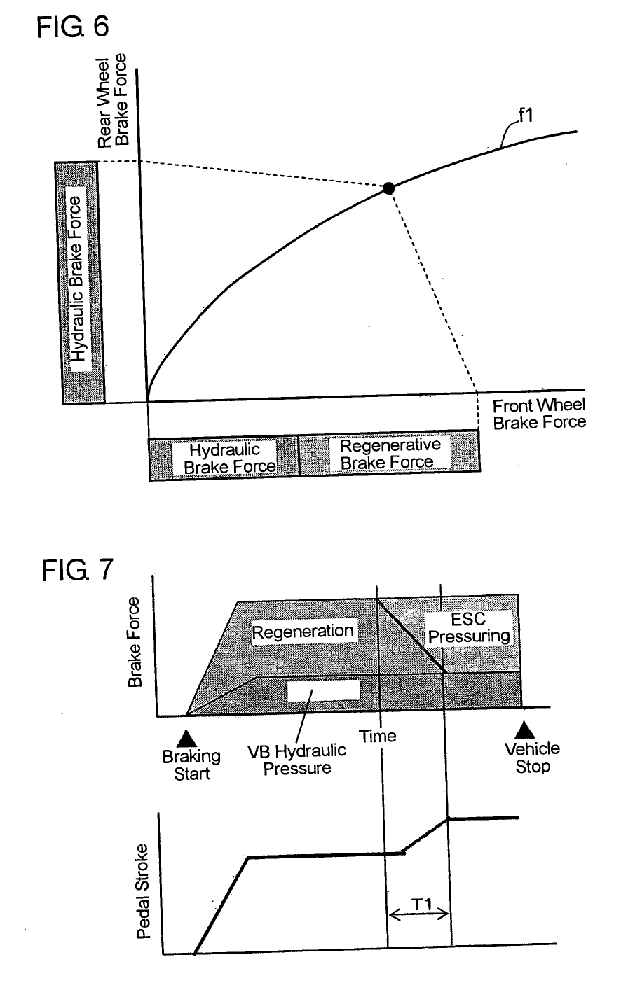

In this case, front-rear brake force distribution regulating means regulates the predetermined front-rear brake force distribution for the front and rear systems in accordance with an ideal brake force distribution curve fl shown in FIG. 6. The brake force detecting means 40 detects the brake forces generated on the respective wheels of the front and rear systems. Where the brake forces detected by the brake force detecting means 40 lacks in terms of the regulated front-rear brake force distribution, the brake ECU 13 generates controlled fluid pressures by driving the pumps 38 of the hydraulic brake device 11 and by controlling the solenoid fluid pressure proportional control valves 32, whereby the controlled hydraulic brake forces in dependence on the controlled fluid pressures are generated on the wheels to compensate for the lack in terms of the front-rear brake force distribution.

Specifically, the brake forces for the front wheels and the rear wheels are respectively controlled to follow the ideal brake force distribution curve (f1) shown in FIG. 6. At this time, in the foregoing embodiment, since the regenerative brake force can be applied only to the front wheels 23f, the front wheel brake force is applied to be the sum of the hydraulic brake force (i.e., the base hydraulic brake force plus the controlled hydraulic brake force) and the regenerative brake force, whereas the rear wheel brake force is applied to be the hydraulic brake force (i.e., the base hydraulic brake force plus the controlled hydraulic brake force) only. Further, when the brake force on the front wheels 23f or the rear wheels 23r lacks in comparison with the brake force derived along the ideal brake force distribution curve (f1), it can be done to compensate for the lack with the controlled hydraulic brake. With this, the stability of the vehicle can be kept further highly during the braking operation.

Further, when the variation is detected by the variation detecting means (i.e., steps 104 and 110 to 114), front-rear brake force distribution compensating means compensates for the lack in terms of the front-rear brake force distribution, so that the stability of the vehicle can be kept further highly during the braking operation.

Further, since the fluid pressure sensors 40 are arranged downstream of the solenoid fluid pressure proportional control valves 32 and since the brake force compensating means or the front-rear brake force distribution compensating means controls the solenoid fluid pressure proportional control valves 32 in dependence on the fluid pressure sensors 40, the feedback control in dependence on the fluid pressure sensors 40 is performed on the solenoid fluid pressure proportional control valves 32 to supply the controlled fluid pressures to the wheel cylinder 30. As a consequence, fluctuation does not take place of the controlled fluid pressure supplied to the wheel cylinder 30, so that a good feeling can be obtained at the deceleration speed.

Further, the solenoid fluid pressure proportional control valves 32 are provided for the plural separate systems, and the fluid pressure sensors 40 are arranged downstream of the solenoid fluid pressure proportional control valves 32 for the respective systems. With this arrangement, the feedback control is performed on the solenoid fluid pressure proportional control valves 32 in dependence on the fluid pressure sensors 40 arranged downstream of the solenoid fluid pressure proportional control valves 32 for the respective systems thereby to supply the controlled fluid pressures from the controlled hydraulic brake force applying device 43 to the respective wheel cylinders 30. Therefore, it can be realized to supply the controlled fluid pressures to the respective wheel cylinders 30 accurately and to apply appropriate controlled hydraulic fluid forces to the respective wheels.

Further, when the variation occurs in the regenerative brake force, the brake ECU 13 detects the variation in the regenerative brake force generated by the regenerative brake device 12, through steps 104, 110 to 114. When the variation is detected through steps 104, 110 to 114, the step 116 is executed to drive the pumps 38 of the hydraulic brake device 11 and to control the solenoid fluid pressure proportional control valves 32 thereby to generate the controlled fluid pressures. Then, the brake ECU 13 generates on the wheels the controlled hydraulic brake forces based on the controlled fluid pressures thereby to compensate for the lack of the regenerative brake force due to the variation which is detected through steps 104, 110 to 114. Consequently, with the simplified construction and regardless of the variation in the regenerative brake force, the brake force demanded by the driver can be applied stably.

Further, step 104 is executed to calculate the target regenerative brake force of the regenerative brake device 12 based on the braking manipulation, step 110 is executed to input the actual regenerative brake force which the regenerative brake device 12 has actually applied to the front wheels 23f in response to the target regenerative brake force calculated at step 104, step 112 is executed to calculate the difference between the target regenerative brake force calculated at step 104 and the actual regenerative brake force input at step 110, and step 114 is executed to detect the occurrence of the variation in the regenerative brake force if the calculated difference is larger than the predetermined value (a). Thus, the variation in the regenerative brake force can be detected reliably through the steps 104 and 110 to 114 which constitutes the variation detecting means.

Further, step 104 is executed to calculate the target regenerative brake force of the regenerative brake device 12 based on the braking manipulation, step 110 is executed to input the actual regenerative brake force which the regenerative brake device 12 has actually applied to the front wheels 23f in response to the target regenerative brake force calculated at step 104, step 112 is executed to calculate the difference between the target regenerative brake force calculated at step 104 and the actual regenerative brake force input at step 110, and step 116 is executed to control the controlled fluid pressures of the hydraulic brake device 11 to make the controlled brake forces correspond to the difference calculated at step 112. With this construction, it becomes possible for steps 104, 110, 112, 116 constituting the brake force compensating means to compensate the brake force accurately and reliably.

Further, the brake ECU 13 which is a computer for controlling the hydraulic brake device 11 is made to execute the vehicle brake control program including the variation detecting step (steps 104 and 110 to 114) of detecting the variation in the regenerative brake force actually generated by the regeneration braking device 12 and the brake force compensating step (steps 104 and 110, 112, 116) of compensating for the lack of the brake force due to the variation in the regenerative brake force detected by the variation detecting step, with the controlled hydraulic brake force derived from the controlled fluid pressure which is generated by driving the pumps 38 of the hydraulic brake device 11. With this program, the brake force demanded by the driver can be stably applied regardless of the variation in the regenerated brake force even when the regenerative brake force varies.

In the foregoing first embodiment, a brake stroke sensor for detecting the stroke amount of the brake pedal 20 may be utilized as the braking manipulation state detecting means. The stroke amount represents the braking manipulation state in this modification.

In the foregoing first embodiment, when the regenerative brake force (the portion labeled “Regeneration” in FIG. 7) decreases with an decrease in the vehicle speed during the regeneration cooperative control, the total brake force for the vehicle decreases, and an occasion finally arises wherein nothing can be obtained except for the base hydraulic brake force (the portion labeled “VB Hydraulic Pressure” in FIG. 7. In this occasion, in the application of the present invention, the controlled hydraulic brake force (the portion labeled “ESC Pressuring” in FIG. 7) is applied in substitution for the regenerative brake force, whereby the total brake force can be kept to be constant by the compensation for the decreased portion of the regenerative brake force. Herein, applying the controlled hydraulic brake force in substitution for the regenerative brake force in this way is referred to as the replacement of the regenerative brake force with the controlled hydraulic brake force.

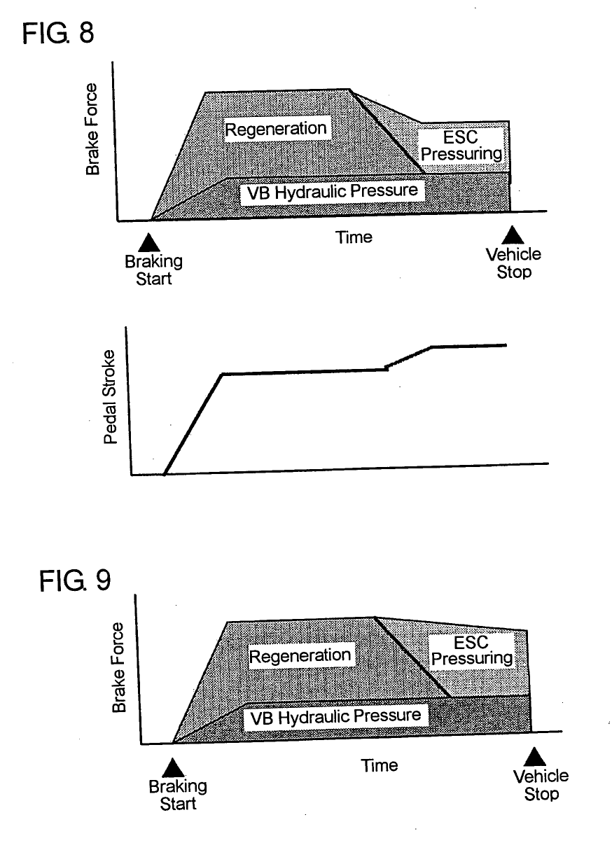

Referring also to FIG. 7, for the period T1 during which the replacement occurs, the total brake force is kept to be constant not to vary, but it may occur that a strange feeling is given to the driver. To obviate this drawback, as shown in FIGS. 8 and 9, it is preferable to execute a control for decreasing the total brake force, that is, the controlled hydraulic brake force over the period which continues from the starting time point of the replacement until the vehicle stop time point is reached. By doing so, the controlled hydraulic brake force which is to be generated during the period for the replacement can be suppressed to be smaller than that in the aforementioned case (the case shown in FIG. 7). As a result, the withdrawal amount of the brake pedal 20 can be suppressed to the degree that the driver no longer feels the withdrawal of the brake pedal 20, and the variation amount of the vehicle deceleration speed can be suppressed to the degree that the driver no longer feels the variation in the vehicle deceleration speed.

More specifically, it does not occur that the driver has the strange feeling if the gradient of the regeneration brake force is set to achieve the following predetermined conditions and if the controlled hydraulic brake force is set in dependence on the to meet the gradient of the regeneration brake force so set.

### Predetermined Conditions

1. A replacement vehicle speed range in which the foregoing replacement is performed is set to be less than a predetermined speed.

2. The moving amount of the brake pedal is set to be less than a predetermined value.

3. The moving speed of the brake pedal is set to be less than a predetermined value.

4. The variation ratio of the vehicle deceleration speed is set to be less than a predetermined value.

For example, in the case of above 1, the decrease of the regenerative brake force is started when the vehicle speed reaches a predetermined speed V1, and the regenerative brake force is discontinued when the vehicle speed further decreases to another predetermined speed V2. That is, the replacement control is started when the predetermined speed V1 is reached and is stopped when the predetermined speed V2 is reached. Also in the above 2 and the above 3, the replacement control is executed similarly. However, in the above 2 and the above 3, the control is executed in dependence on the variation amount of the master cylinder pressure sensor 29. In the above 4, the control is executed in dependence on the variation in the sum of the wheel cylinder pressure and the regenerative brake force. The replacement control can be done by the brake ECU 13.

### Second Embodiment

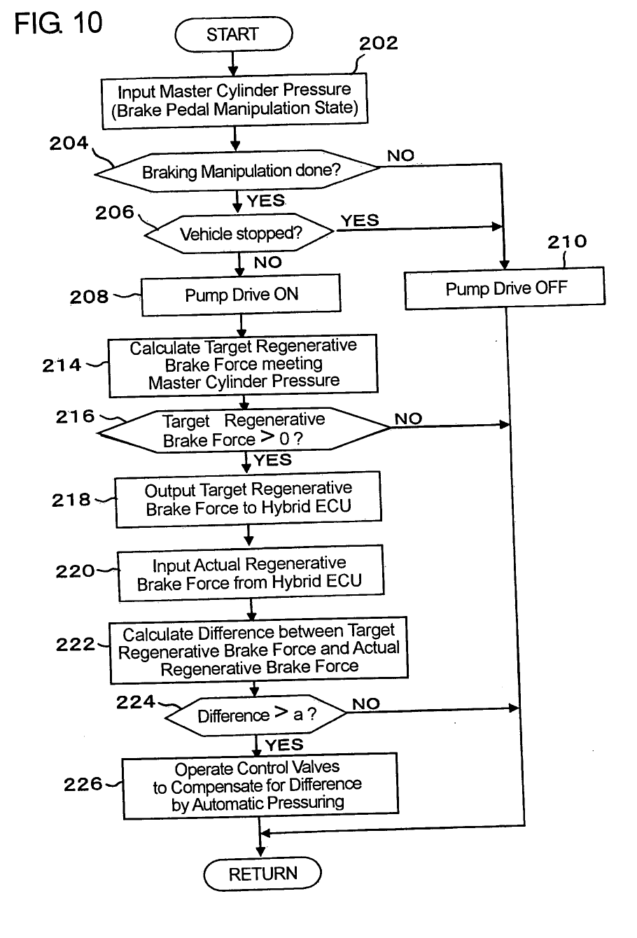

A second embodiment shown in FIG. 10 differs from the first embodiment in that the control start for the pump drive is made at the same timing as the start of the braking manipulation. The hydraulic circuit arrangement of the hydraulic brake device 11 shown in FIG. 2 is similarly applicable to the second embodiment, and therefore, a flow chart used in the second embodiment will be described with reference to FIG. 2.

Referring now to FIG. 10, the brake ECU 13 executes a program corresponding to the flow chart at a predetermined minute time interval when an ignition switch (not shown) of the vehicle is in ON state. The brake ECU 13 takes thereinto the master cylinder pressure representing the manipulating state of the brake pedal 20, from the fluid pressure sensor 29 (step S202). Then, at step 204, it is judged whether or not the braking manipulation is being performed, and if the judgment at step 204 is YES, it is further judged at step 206 whether or not the vehicle has been stopped. In the case that the braking manipulation is occurring but the vehicle has not been stopped, a pump drive ON command is given at step 208, whereby the brake ECU 13 starts the electric motor 39 to drive pumps 38. On the contrary, where the braking manipulation is not being performed or the vehicle has been stopped, a pump drive OFF command is given at step 210, and the program is returned with the pumps 38 remaining stopped.

Upon driving the pumps 38, if the solenoid fluid pressure proportional control valves 32 are kept fully opened and if the solenoid shut-off valves 46 are brought into open state at the same time as the driving of the pumps 38, the brake fluids discharged from the pumps 38 are only circulated through the solenoid fluid pressure proportional control valves 32, the solenoid shut-off valves 46 and the pumps 38, in which case the fluid pressures acting on the wheel cylinders 30 are not influenced by the driving of the pumps 38 to be kept at the base fluid pressures generated by the master cylinder 25.

After the pump drive ON is given at step 208, step 214 (target regenerative brake force calculating means) is reached, at which calculation is made for a target regenerative brake force which depends on the master cylinder pressure input at step 202. For this calculation, the brake ECU 13 uses the aforementioned map, table or arithmetic expression which is stored in advance to show the relation between the master cylinder pressure or the braking manipulation state and the target regenerative brake force.

It is judged at step 216 whether the calculated target regenerative brake force is larger than zero, and if being larger than zero, the calculated target regenerative brake force is output to the hybrid ECU 15, but control is not executed on the controlled hydraulic brake force applying device 43 (step 218). Accordingly, where the brake pedal 20 has been stepped on, as is the aforementioned case, the hydraulic brake device 11 only applies the base hydraulic brake forces (static brake force) to the wheels 23f, 23r. Further, the hybrid ECU 15 has input thereto a regeneration demand value indicating the target regenerative brake force, controls the electric motor 14 through the inverter 16 to generate the regenerative brake force in independence on the demand value and taking the vehicle speed, the charged state of the battery 18 and so on into consideration, and outputs an actual regeneration execution value to the brake ECU 13. Thus, when the braking manipulation is being performed and when the target regenerative brake force is larger than zero, the regenerative brake force is applied to the wheels 23 to be further added in addition to the base hydraulic brake force.

The brake ECU 13 detects the variation in the regenerative brake force which has been actually generated by the regenerative brake device 12. Specifically, the brake ECU 13 inputs thereto the actual regeneration execution value representing the actual regenerative brake force which the regenerative brake device 12 has actually applied to the front wheels 23f in response to the target regenerative brake force calculated at step 214 (steps 220: actual regenerative brake force inputting means), calculates the difference between the target regenerative brake force calculated at step 214 and the actual regenerative brake force input at step 220 (step 222: difference calculating means), and judges at step 224 (judgment means) whether or not the difference is larger than the predetermined value (a). Thus, when the calculated difference is larger than the predetermined value (a) to detect the variation in the regenerative brake force, the judgment at step 224 becomes YES, the solenoid fluid pressure proportional control valves 32 of the hydraulic brake device 11 are controlled in dependence on the calculated difference, whereby compensation is made for the lack of the brake force due to the variation in the regenerative brake force pressurized automatically (step 226).

More specifically, the brake ECU 13 applies an electric current to the linear solenoids 33 of the solenoid fluid pressure proportional control valves 32 to make the fluid pressures correspond to the difference between the target regenerative brake force calculated at step 214 and the actual regenerative brake force input at step 220, that is, the difference calculated at step 222. At this time, it is further preferable that a feedback control is performed on the linear solenoids 33 so that the fluid pressures in the wheel cylinders 30 detected by the fluid pressure sensor 40 are controlled to come into coincidence with the controlled fluid pressures.

By the aforementioned control of the solenoid fluid pressure proportional control valves 32, the fluid pressures supplied to the wheel cylinders 30 from the pumps 38 which have already been driven upon the braking manipulation are controlled to the controlled fluid pressures corresponding to the difference between the target regenerative brake force and the actual regenerative brake force, and the hydraulic brake device 11 applies to the wheels 23 the controlled hydraulic brake forces which correspond to the difference between the target regenerative brake force and the actual regenerative brake force.

In the second embodiment, since the driving of the pumps 38 is started at the time of the braking manipulation, it can be realized that the driver in the process of stepping on the brake pedal 20 is practically made not to feel the withdrawal of the brake pedal 20 which would otherwise occurs when the pumps 38 begin to be driven, so that the feeling in the braking manipulation can be enhanced.

Further, since releasing the brake pedal 20 causes the pumps 38 to be stopped, it does not occur that the behavior of the brake pedal 20 attributed to the stopping of the pumps 38 is conveyed to the driver, so that the feeling about the braking manipulation is not affected.

Although in the foregoing second embodiment, an example has been described wherein releasing the brake pedal 20 causes the pumps 38 to be stopped, an alternative condition for stopping the pumps 38 may be such that the pumps 38 are turned to OFF upon detection of the vehicle stop. In this case, since the pumps 38 can be stopped in mid course of the braking manipulation, the consumption of the battery 18 can be suppressed in comparison with the case that releasing the brake pedal 20 causes the pumps 38 to be stopped. This advantageously results in improving the efficiency of the battery 18.

Although in the foregoing embodiments, the circuit arrangement is provided on an FF (front-engine front-drive) car, it may be provided on an FR (front-engine rear-drive) car. Although in the foregoing embodiments, the vacuum booster 27 is employed as booster device, the stepping force acting on the brake pedal 20 may be boosted by charging an accumulator with the fluid pressure generated by one of the pumps 38 and by applying the fluid pressure onto a piston contained in a hydraulic booster.

Various features and many of the attendant advantages in the foregoing first and second embodiments will be summarized as follows:

In the vehicle brake device in the foregoing first embodiment typically shown in FIGS. 1 to 5, a regeneration cooperative control can be realized by combining the heretofore existent hydraulic brake device 11 and the regenerative brake device 12. Thus, it can be realized to provide the vehicle brake device in which the regeneration cooperative control is possible in the simplified construction and at the low cost. Further, the controlled fluid pressures are generated through driving the pumps 38 of the hydraulic brake device 11 and through controlling the solenoid fluid pressure proportional control valves 32, so that the controlled hydraulic brake forces in dependence on the controlled fluid pressures are generated on the wheels 23 to compensate for the lack of the regenerative brake force due to the variation which is detected by the variation detecting means (steps 104 and 110 to 114). Accordingly, since the pressure regulating means 32 which constitutes the hydraulic brake device 11 which has been existent heretofore is utilized as the brake force compensating means, it can be realized to stably supply the brake force demanded by the driver in the simplified construction regardless of the variation in the regenerative brake force.

Also in the vehicle brake device in the foregoing embodiments typically shown in FIGS. 1 to 3 and 10, upon occurrence of the variation of the regenerative brake force, the variation detecting means (steps 104 and 110 to 114, steps 214 and 220 to 224) detects the variation from the target regenerative brake force of the regenerative brake force actually generated by the regenerative brake device 12, the brake force compensating means (step 116, step 226) generates the controlled fluid pressures through driving the pump 38 of the hydraulic brake device 11 and through controlling the solenoid fluid pressure proportional control valves 32 so that the controlled hydraulic brake forces depending on the controlled fluid pressures are generated on the front wheels 23f to compensate for the lack of the regenerative brake force due to the variation which is detected by the variation detecting means. Accordingly, by utilizing as the brake force compensating means the pressure regulating means 32 constituting the hydraulic brake device 11 which has been existence heretofore, it can be realized to apply the brake force demanded by the driver with the simplified construction stably regardless of the variation of the regenerative brake force.

Also in the vehicle brake device in the foregoing embodiments typically shown in FIGS. 1 and 2, the booster device 27 is connected to the master cylinder 25 for boosting the brake manipulation, and the master cylinder 25 generates the base fluid pressures which correspond to the force boosted by the booster device 27. Thus, it is possible to utilize the hydraulic brake device 11 which has been wide spread heretofore and which is reliable and inexpensive.

Also in the vehicle, brake device in the foregoing embodiment typically shown in FIGS. 1 and 2, the brake force compensating means (step 116, step 226) controls the solenoid fluid pressure proportional control valves 32 which are respectively provided in front and rear brake systems 24f, 24r of the vehicle which has the brake systems for the front and rear systems. Thus, it can be realized to control the brake forces for the front and rear systems 24f, 24r independently and reliably.

Also in the vehicle brake device in the foregoing embodiment typically shown in FIGS. 1 to 3, the front-rear brake force distribution regulating means regulates the predetermined front-rear brake force distribution for the front and rear systems 24f, 24r, the brake force detecting means 40 detects brake forces generated on the respective wheels 23 in the front and rear systems 24f, 24r, and when the brake forces detected by the brake force detecting means 40 lacks in terms of the regulated front-rear brake force distribution, the front-rear brake force distribution compensating means generates the controlled fluid pressures through driving the pumps 38 of the hydraulic brake device 11 and through controlling the solenoid fluid pressure proportional control valves 32 so that the controlled hydraulic brake forces depending on the controlled fluid pressures are generated on the wheels 23 to compensate for the lack in terms of the front-rear brake force distribution. Accordingly, it can be realized to apply the brake force demanded by the driver to the front and rear systems 24f, 24r stably regardless of the variation of the regenerative brake force.

Also in the vehicle brake device in the foregoing embodiments typically shown in FIGS. 1 and 2, also in the vehicle having the brake system composed of the front and rear systems 24f, 24r, the regeneration cooperative control can be realized by combining the hydraulic brake system 11 which has been existence heretofore, with the regenerative brake device 12. Accordingly, it is possible to provide the vehicle brake device which is capable of performing the regeneration cooperative control with the simplified and inexpensive construction. Further, the variation detecting means (steps 104 and 110 to 114) detects the variation from the target regenerative brake force of the regenerative brake force actually generated by the regenerative brake device 12, the front-rear brake force distribution regulating means regulates the predetermined front-rear brake force distribution for the front and rear systems 24f, 24r, the brake force detecting means 40 detects the brake forces generated on the respective wheels 23 in the front and rear systems 24f, 24r, and when the brake forces detected by the brake force detecting means 40 lack in terms of the regulated front-rear brake force distribution, the front-rear brake force distribution compensating means generates the controlled fluid pressures through driving the pumps 38 of the hydraulic brake device 11 and through controlling the solenoid fluid pressure proportional control valves 32 so that the controlled hydraulic brake forces depending on the controlled fluid pressures are generated on the wheels 23 to compensate for the lack in terms of the front-rear brake force distribution.

Also in the vehicle brake device in the foregoing embodiments typically shown in FIGS. 1 to 3 and 10, when the variation detecting means (steps 104 and 110 to 114, steps 214 and 220 to 224) detects the variation, the front-rear brake force distribution compensating means compensates for the lack in terms of the front-rear brake force distribution. Thus, the stability of the vehicle upon braking can be kept further highly.

Also in the vehicle brake device in the foregoing embodiments typically shown in FIGS. 1 to 3 and 10, the fluid pressure sensors 40 are arranged downstream of the solenoid fluid pressure proportional control valves 32, and the brake force compensating means (step 116, step 226) or the front-rear brake force compensating means controls the solenoid fluid pressure proportional control valves 32 based on the outputs of the fluid pressure sensors 40.

Also in the vehicle brake device in the foregoing embodiment typically shown in FIGS. 1 to 3 and 10, the regeneration cooperative control can be realized by combining the hydraulic brake system 11 which has been existence heretofore, with the regenerative brake device 12. Accordingly, it is possible to provide the vehicle brake device which is capable of performing the regeneration cooperative control with the simplified and inexpensive construction. Further, at the occurrence of the variation of the regenerative brake force, the variation detecting means (steps 104 and 110 to 114, steps 214 and 220 to 224) detects the variation from the target regenerative brake force of the regenerative brake force actually generated by the regenerative brake device 12, and when the variation is detected by the variation detecting means (steps 104 and 110 to 114, steps 214 and 220 to 224), the brake force compensating means (step 116, step 226) generates the controlled fluid pressures through driving the pumps 38 of the hydraulic brake device 11 and through controlling the solenoid fluid pressure proportional control valves 32 so that the controlled hydraulic brake forces depending on the controlled fluid pressures are generated on the front wheels 23f to compensate for the lack of the regenerative brake force due to the variation which is detected by the variation detecting means (steps 104 and 110 to 114, steps 214 and 220 to 224). Accordingly, it can be realized to apply the brake force demanded by the driver stably regardless of the variation of the regenerative brake force.

Also in the vehicle brake device in the foregoing embodiments typically shown in FIGS. 1 to 3 and 10, the target regenerative brake force calculating means (step 104, step 214) calculates the target regenerative brake force of the regenerative brake device 12 in dependence on the braking manipulation state, the actual regenerative brake force inputting means (step 110, step 220) inputs the actual regenerative brake force which the regenerative brake device 12 has actually applied to the front wheels 23f in response to the target regenerative brake force calculated by the target regenerative brake force calculating means (step 104, step 214), the difference calculating means (step 112, step 222) calculates the difference between the target regenerative brake force calculated by the target regenerative brake force calculating means (step 104, step 214) and the actual regenerative brake force input by the actual regenerative brake force inputting means (step 110, step 220), and the judgment means (step 114, step 224) detects the occurrence of the variation in the regenerative brake force if the difference calculated by the difference calculating means (step 112, step 222) is larger than the predetermined value (a). Therefore, it can be realized to reliably detect the variation in the regenerative brake force by the variation detecting means (steps 104 and 110 to 114, steps 214 and 220 to 224,).

Also in the vehicle brake device in the foregoing embodiments typically shown in FIGS. 1 to 3 and 10, the target regenerative brake force calculating means (step 104, step 214) calculates the target regenerative brake force of the regenerative brake device 12 in dependence on the braking manipulation state, the actual regenerative brake force inputting means (step 110, step 220) inputs the actual regenerative brake force which the regenerative brake device 12 has actually applied to the front wheels 23f in response to the target regenerative brake force calculated by the target regenerative brake force calculating means (step 104, step 214), the difference calculating means (step 112, step 222) calculates the difference between the target regenerative brake force calculated by the target regenerative brake force calculating means (step 104, step 214) and the actual regenerative brake force input by the actual regenerative brake force inputting means (step 110, step 220), and the control means (step 116, step 226) generates the controlled fluid pressures to coincide with the brake forces corresponding to the difference calculated by the difference calculating means (step 112, step 222). Thus, the brake force compensating means 32 can be enabled to compensate the brake force reliably and accurately.

### Third Embodiment

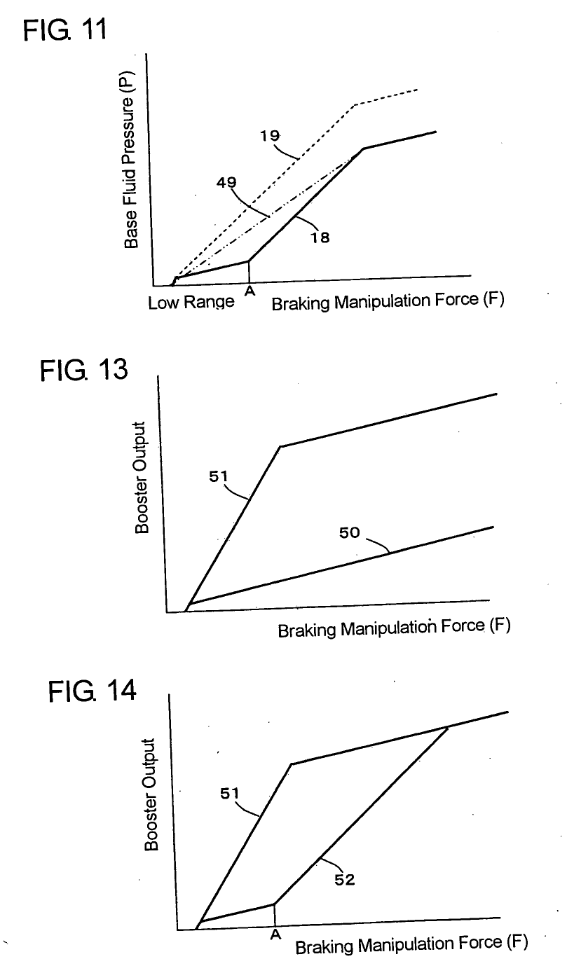

A vehicle brake device in a third embodiment according to the present invention is designed for hybrid vehicles and uses the same system circuit diagram as shown in FIGS. 1 and 2 used in the foregoing first embodiment. Therefore, the third embodiment will be described hereinafter with reference to FIGS. 1 and 2 in addition to FIGS. 11 to 14, wherein description will be directed to the respects different from the foregoing first embodiment for the sake of brevity.

Referring now to FIGS. 1 and 2, a rotational shaft of the electric motor 14 is always in driving connection with the front left and right wheels 23fl, 23fr through a reduction gear train. The inverter 16 converts the direct current power of the battery 18 to an alternate current power in dependence on control signals supplied from the hybrid ECU 15 to supply the converted alternate current power to the electric motor 14 and also converts the alternate current power generated by the electric motor 14 converts into a direct current power to charge the battery 18 therewith.

In the third embodiment, the vacuum booster 27 has a property that a boosting ratio which is the ratio of the increase of output to the increase of the braking manipulation force is low when the same is in a low range, but becomes higher when the braking manipulation force exceeds the low range. The low range means the range in which the braking manipulation force is generated when the driver performs an ordinary or average braking manipulation. The braking manipulation force exceeding the low range means the braking manipulation force which is generated when the driver steps the brake pedal fairly strongly at the occasion that a pedestrian suddenly comes out or that the traffic signal changes with the vehicle coming close to an intersection. The boosting ratio in the low range is set to be fairly lower than the boosting ratio of a vacuum booster which is conventionally used for an engine-driven vehicle, and the boosting ratio over the low range is set to be the same degree as the boosting ratio of the conventionally used vacuum booster. Thus, as shown in FIG. 11, the relation 18 between the base fluid pressure (P) output from the master cylinder 25 in dependence on the force boosted by the booster device 27 and the braking manipulation force (F) is such that a servo ratio which is the ratio of the increase of the base fluid pressure (P) to the increase of the braking manipulation force (F) is set to be fairly lower than that usually used in the engine-driven vehicle, in the low range wherein the braking manipulation force (F) is less than a value (A) and is set to be the same degree as the boosting ratio of the conventionally used vacuum booster in a range exceeding the low range.

The target brake force depending on the braking manipulation force (F) is indicated by the broken line 19 in FIG. 11, and the difference between the target brake force and the base fluid pressure (P) corresponds to a predetermined regenerative brake force which is to be covered by the regenerative brake force. As apparent from FIG. 11, in comparison with the case that the servo ratio is made to be straight as indicated by the two-dotted chain line 49 in FIG. 11, the portion in the low range corresponding to the predetermined regenerative brake force is increased as a result of lowering the servo ratio in the low range, and the sharing ratio of the predetermined regenerative brake force to the target brake force is set to be higher in the low range. The relation 18 of the base fluid pressure (P) with the braking manipulation force (F) and the relation 19 of the target brake force to the braking manipulation force (F) shown in FIG. 11 are stored in advance in the memory of the brake ECU 13 in the form of a map, table or arithmetic expression.

The vacuum booster 27 is known having the aforementioned property that the boosting ratio is low in the low range of the braking manipulation force and becomes high in the range exceeding the low range. One described in, e.g., Japanese unexamined, published patent application No. 10-250565 can be used as the vacuum booster 27. Where the vacuum booster 27 is made to be a so-called two-step servo booster which has a property that an approximately straight line determining the boosting ratio in the low range is bent in an upward direction when going beyond the low range, the position (A) at which the boosting ratio is bent may be determined in dependence on the capability that the regenerative brake device 12 has in generating the regenerative brake force, to correspond to, e.g., its maximum regeneration capability.

The width of the low range can be properly set to meet a desired property. The boosting ratio in the range exceeding the low range is not restricted to the boosting ratio of the vacuum booster which is usually used in engine-driven vehicles and can be set to meet a desired property as it is set to be fairly high for performing the brake assist control for example.

The hydraulic brake system 11 is capable of increasing the braking manipulation force of the driver by the booster device 27 at the predetermined boosting ratio, of generating a base fluid pressure depending on the increased braking manipulation force by the master cylinder connected to the booster device 27, and of applying the generated base fluid pressure to the wheel cylinders 30 of the respective wheels 23 which are connected to the master cylinder 25 by way of passages 26 having the fluid pressure proportional control valves 32 thereon, thereby to make the respective wheels 23 generate the base hydraulic brake force. The hydraulic brake system 11 is also capable of applying a controlled fluid pressure which is generated by driving the pumps 38, to the wheel cylinders 30 thereby to make the wheels 23 associated with the wheel cylinders 30 generate the controlled hydraulic brake force.

The regenerative brake device 12 in the third embodiment is composed of the electric motor 14 drivingly connected to the front wheels 23f and a regenerative brake force generating device 44 for causing the electric motor 14 to perform regenerative braking so that the regenerative brake force is generated on the front wheels 23f drivingly connected to the electric motor 14.

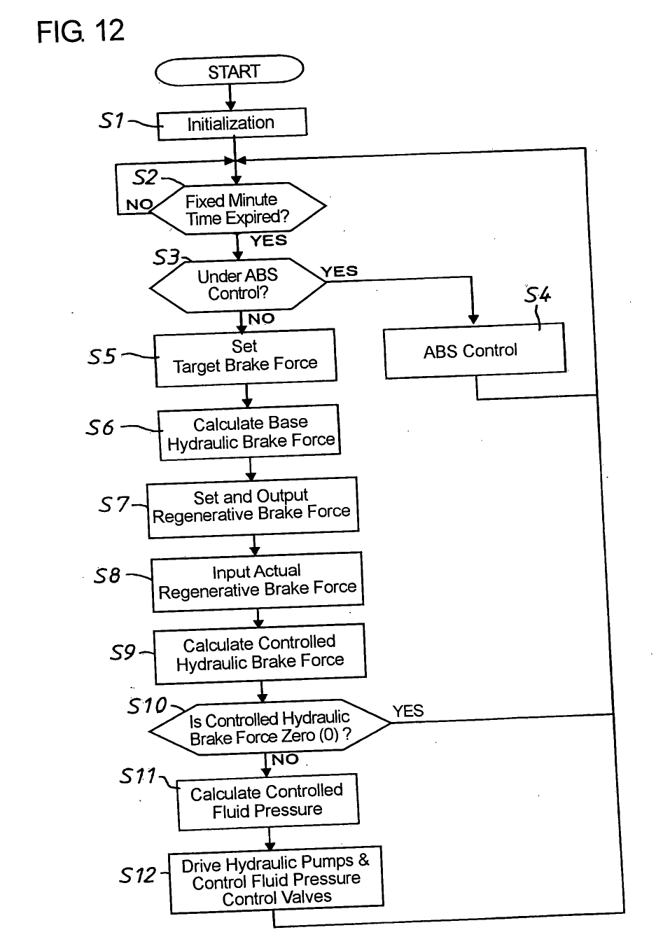

The brake ECU 13 in the third embodiment has stored therein a cooperative control program shown in FIG. 12. The cooperative control program is designed for setting a target brake force to be generated by the wheels 23 in dependence on the braking manipulation force, for commanding to the regenerative brake force generating device 44 a predetermined regenerative brake force which is the difference made by subtracting from the target brake force the base hydraulic brake force which the brake means 31 causes the wheels 23 to generate by receiving in the wheel cylinders 30 the base fluid pressure (P) output from the master cylinder 25, for inputting thereto an actual regenerative brake force generated by the regenerative brake force generating device 44 in response to the command, and for calculating a controlled hydraulic brake force which is the difference between the target brake force and the actual regenerative brake force. The cooperative control program is further designed for calculating a controlled fluid pressure which is to be supplied to the wheel cylinders 30 in order for the brake means 31 to generate a controlled hydraulic brake force on the wheels 23, and for applying a control current to the linear solenoids 33 of the solenoid fluid pressure proportional control valves 32 so that the fluid pressure of the brake fluids which are supplied from the pumps 38 rotationally driven by the motor 39 to the wheel cylinders 30 is controlled to the controlled fluid pressure.

Further, the brake ECU 13 in the third embodiment executes various programs in dependence on detection signals from the fluid pressure sensor 29, the wheel speed sensors 47 for detecting the wheel speeds of the respective wheels 23, and the like, outputs control signals to the solenoid fluid pressure proportional control valves 32r, 32f, the ABS control valves 37f, 37r, the electric motor 39 and the like and supplies the wheel cylinders 30 with controlled fluid pressures so that the brake means 31 makes the wheels 23 generate the desired hydraulic brake force.

Next, the operation of the hybrid vehicle brake device in the third embodiment will be described in accordance with a flow chart shown in FIG. 12. When the brake pedal 20 is stepped on, the braking manipulation force is boosted by the vacuum booster 27 to push a piston rod of the master cylinder 25, and the base fluid pressures are sent out from the respective pressure chambers 25f, 25r. The base fluid pressures are supplied to the respective wheel cylinders 30f, 30r through the solenoid fluid pressure proportional control valves 32f, 32r and the solenoid shut-off valves 34f, 34r all kept at the open position, and thus, the brake means 31f, 31r cause the wheels 23f, 23r to generate the base hydraulic brake force. When having input thereto the base fluid pressure from the fluid pressure sensor 29 upon stepping of the brake pedal 20, the brake ECU 14 starts the cooperative control program shown in FIG. 12, resets temporal memories such as counters, flags and the like for initialization (step S1), and executes step S2 and those successive thereto each time the expiration of a fixed or predetermined minute time is judged at step S2.

The brake ECU 13 judges whether or not the starting condition for the anti-lock brake control is satisfied or whether or not the anti-lock brake control is under execution, and when confirming the satisfaction or the execution, executes the anti-lock brake control by controlling the open/close operations of the solenoid shut-off valves 34, 36 thereby to control the fluid pressures in the respective wheel cylinders 30, whereby the hydraulic brake force to be generated on each of the wheels 23 is increased, retained and reduced not to make each wheel 23 slip on the road surface (step S4). While the anti-lock brake control is executed, the solenoid shut-off valves 46 are closed, the pumps 38 are driven by the electric motor 39, and the solenoid valves 36 are controlled to be opened or closed to replenish the pumps 38 with the brake oils discharged toward the reservoirs 35.

When the starting condition for the anti-lock brake control is not satisfied or when the anti-lock brake control is not under execution, the brake ECU 13 obtains a braking manipulation force (F) corresponding to the base fluid pressure (P) detected by the fluid pressure sensor 29, based on the relation 18 between the base fluid pressure (P) and the brake manipulation force (F) set in the graph shown in FIG. 11, also obtains a target brake force which is to be generated on the wheels 23 in correspondence to the brake manipulation force (F), by reference to the map or table or by an arithmetic expression (step S5), and further obtains a base hydraulic brake force which the brake means 31 is to generate on the wheels 23 in dependence on the base fluid pressure detected by the fluid pressure sensor 29, by reference to another map or table or by another arithmetic expression (step S6). Then, the brake ECU 13 outputs to the hybrid ECU 15 a predetermined regenerative brake force which is the difference made by subtracting the base hydraulic brake force from the target brake force (step S7). By controlling the open/close operation of the inverter 16 in dependence on the predetermined regenerative brake force, the hybrid ECU 15 makes the electric motor 14 perform a regenerative braking thereby to make the wheels 23 to generate the regenerative brake force and calculates an actual regenerative brake force which the electric motor 14 has actually made the wheels 23 to generate in dependence on an electric current of the regeneration power which is detected by a sensor in the inverter 16 to input the actual regenerative brake force to the brake ECU 13 (step S8).

The brake ECU 13 calculates a controlled hydraulic brake force being the difference between the target brake force and the actual regenerative brake force (step S9), and returns to step S2 when the difference is zero (step 10). When the difference is not zero, the brake ECU 13 calculates a controlled fluid pressure which the brake means 31 is to supply to the wheel cylinders 30 for causing the wheels 23 to generate the controlled hydraulic brake force, by reference to another map, table or by another arithmetic expression (step S11). Then, the brake ECU 13 drives the electric motor 39 to drive the pumps 38 and applies an electric current to the linear solenoids 33 of the solenoid fluid pressure proportional control valves 32 so that the fluid pressures of the brake fluids supplied from the pumps 38 to the wheels cylinders 30 become the controlled fluid pressure (step S12). The fluid pressures are controlled by the solenoid fluid pressure proportional control valves 32 to the controlled fluid pressure, whereby the hydraulic brake device 11 makes the wheels 23 to generate the controlled hydraulic brake force corresponding to the difference between the target brake force and the actual regenerative brake force. The aforementioned steps S9 and the like constitute variation detecting means for detecting the variation from the predetermined regenerative brake force of the regenerative brake force which has been actually generated by the regenerative brake device 12, and the aforementioned steps S10 to S12 constitute brake force compensating means operable upon detection of the variation by the variation detecting means (step S9) for generating the controlled fluid pressure by driving the pumps 38 of the hydraulic brake device 11 and by controlling the fluid pressure proportional control valves 32 and for generating on the wheels 23 the controlled hydraulic brake force depending on the controlled fluid pressure to compensate for the lack of the regenerative brake force due to the detected variation.

When the braking manipulation force (F) is in the low range to be less than the predetermined value (A) shown in FIG. 11, the servo ratio of the increment of the braking manipulation force (F) to the increment of the base fluid pressure (P) is low as described earlier, and the sharing ratio of the predetermined regenerative brake force to the target brake force in the low range becomes high, whereby it can be realized to enhance the energy efficiency. When the braking manipulation force (F) exceeds the low range, the servo ratio goes high to the same degree as that in the conventional engine-driven vehicle, thereby to raise the increase rate of the base fluid pressure (P) which is supplied from the master cylinder 25 to the wheel cylinders 30. Therefore, even when a delay occurs in supplying the controlled fluid pressure from the controlled hydraulic brake force generating device 43 at the time of a sudden braking, the brake means 31 can generate a sufficiently large base hydraulic brake force on the wheels 23.

Where the sharing ratio of the regenerative brake force is too high, the burden on the pumps 38 of the controlled hydraulic brake force generating device 43 becomes large in attaining the target brake force, so that the feeling at the braking operation is deteriorated. Where the sharing ratio of the regenerative brake force is too small, the regenerative brake force has extra or surplus which cannot be used, so that the regeneration efficiency is deteriorated. Where the vacuum booster 27 is made to be the two-step servo booster and where the position (A) at which the boosting ratio is bent is determined in dependence on the capability that the regenerative brake device 12 has in generating the regenerative brake force, to correspond to, e.g., its maximum regeneration capability, it can be realized to enhance the regeneration efficiency and to lighten the burden on the pumps 38, so that the feeling at the braking operation can be improved. Accordingly, the aforementioned advantages can be achieved on the vehicles of various models by adapting the property of the two-step servo booster to the maximum regeneration capability on the model-by-model basis.

Next, the traction control will be described as one example wherein the controlled hydraulic brake force generating device 43 controls the fluid pressure supplied to the wheels cylinders 30, by the solenoid fluid pressure proportional control valves 32 in dependence on the traveling state of the vehicle. In the traction control, the slip amount of the drive wheels (front wheels 23f in this particular embodiment) is obtained by subtracting the vehicle speed which is an average value of the rotational speeds of the rear left and right wheels 23rl, 23rr (i.e., driven wheels) from an average value of rotational speeds of the front left and right wheels 23fl, 23fr (i.e., drive wheels) wherein the rotational speeds are detected by the wheel speed sensors 47, and when the slip amount of the drive wheels 23f exceeds a predetermined value and further increases, the electric motor 39 is driven to drive the pumps 38. A controlled electric current is applied to the linear solenoid 33f of the solenoid fluid pressure proportional control valve 32f connected to the wheel cylinders 30f so that the fluid pressure of the brake fluid supplied from the pump 38f to the wheels cylinders 30f of the front wheels 23f become a fluid pressure depending on the slip amount, and the solenoid shut-off valves 46f are brought into the open state. Thus, the brake fluid discharged from the pump 38f circulates through the solenoid fluid pressure proportional control valve 32f, the solenoid shut-off valve 46f and the pump 38f thereby to supply the controlled fluid pressure to the wheel cylinders 30f, whereby the brake means 31 causes the front wheels 23f to generate a hydraulic brake force depending on the slip amount. Since the linear solenoid 33r of the solenoid fluid pressure proportional control valve 32r connected to the wheel cylinders 30r of the rear wheels 23r being the driven wheels remains deenergized (i.e., opened fully) and since the solenoid shut-off valve 46r is brought into the open state, the fluid pressure in the wheel cylinders 30r is kept to be zero, whereby no hydraulic brake force is generated on the rear wheels 23r. When the slip amount of the drive wheels 23f exceeds the predetermined value but does not increase further, the electric motor 39 is turned to OFF state to stop the pumps 38, and a control current corresponding to the slip amount is applied to the linear solenoid 33f to confine the controlled fluid pressure within the wheel cylinders 30f, whereby a hydraulic brake force is generated on the front wheels 23f. When the slip amount diminishes to be equal to or less than the predetermined value, the electric motor 39 is turned to OFF state to stop the pumps 38, and the solenoid shut-off valves 46 are closed when the fluid pressure of the wheel cylinders 30 is reduced to zero upon deenergization of the linear solenoids 33 of the solenoid fluid pressure proportional control valves 32.

In the aforementioned third embodiment, the vacuum booster 27 has the property that the boosting ratio of the increase of the output to the increase of the brake manipulation force is low when the same is in the low range and becomes high when the brake manipulation force exceeds the low range. Alternatively, as shown in FIG. 13, the vacuum booster 27 may be of the property that it has a fist boosting property 50 that the boosting ratio of the increase of the output to the increase of the brake manipulation force is low when the steeping-in speed of the brake pedal 20 is average and also has a second boosting ratio that the boosting ratio is high when the steeping-in speed is high.

With this arrangement, since the boosting ratio of the booster device 27 is low when the steeping-in speed of the brake pedal 20 is average, the sharing ratio of the regenerative brake force to the target brake force becomes high, so that the energy efficiency can be further enhanced. At an emergency braking having a quick stepping-in speed, the boosting ratio becomes high, and a strong base hydraulic brake force (P) is supplied quickly to the wheel cylinders 30 regardless of the delay of the controlled hydraulic brake force generating device 43 in supplying the controlled fluid pressure, whereby the brake means 31 causes the wheels 23 to generate the strong brake force. For example, a booster device described in a pamphlet for International Publication No. 01/32488 may be employed as the booster device 27 having the second boosting ratio 51 that as shown in FIG. 13, the boosting ratio becomes high when the stepping-in speed is quick.

Further alternatively, as shown in FIG. 14, the vacuum booster 27 may be of the property that it has a first boosting property 52 that as far as the steeping-in speed of the brake pedal 20 is average, the boosting ratio of the increase of the output to the increase of the brake manipulation force is low when the brake manipulation force is in the low range but becomes high when the brake manipulation force exceeds the low range and also has a second boosting ratio 51 that the boosting ratio is high when the steeping-in speed is high.

With this construction, because as far as the steeping-in speed of the brake pedal 20 is average, the boosting ratio of the booster device 27 is low when the brake manipulation force (F) is in the low range, the sharing ratio of the regenerative brake force to the target brake force becomes high, so that the energy efficiency can be enhanced. Because the boosting ratio of the booster device 27 becomes high at the emergency braking wherein the stepping-in speed is fast or quick, a strong base hydraulic brake force (P) is supplied quickly to the wheel cylinders 30 regardless of the delay of the controlled hydraulic brake force generating device 43 in supplying the controlled fluid pressure, whereby the brake means 31 causes the wheels 23 to generate the strong brake force. Further, when the steeping-in speed of the brake pedal 20 is average and when the brake manipulation force (F) exceeds the low range, the boosting ratio of the booster device 27 becomes high thereby to raise the increase rate in the base fluid pressure, so that it can be realized to diminish the feeling about the delay of the brake to work at the emergency braking.

The vacuum booster 27 is known having the property that it has the fist boosting property 52 that as far as the steeping-in speed of the brake pedal 20 is average, the boosting ratio of the increase of the output to the increase of the brake manipulation force is low when the brake manipulation force is in the low range but becomes high when the brake manipulation force exceeds the low range and also has the second boosting ratio 51 that the boosting ratio is high when the steeping-in speed is fast or quick. As the vacuum booster 27, there can be utilized one described in, e.g., Japanese unexamined, published patent application No. 10-250565.

Further alternatively, the booster device 27 may be construed by combing the booster device described in the pamphlet for the aforementioned International Publication No. 01/32488 and having the property that the boosting ratio becomes high when the stepping-in speed is fast, with the booster device described in the aforementioned Japanese unexamined, published patent application No. 10-250565 and having the property that the boosting ratio is low in the low range of the brake manipulation force (F) but becomes high when the low range is exceeded.

Although in the foregoing third embodiment, the hydraulic circuit arrangement is made over the front and rear wheels in the FF car, it may be made over the front and rear wheels in a FR car. Further, a hydraulic circuit arrangement in an X-letter formation may be made in the FF car or FR car, so that the fluid pressure sent out from the fluid pressure chamber 25f of the dual master cylinder 25 is supplied to the wheels cylinders 30fr, 30rl of the brake means 31fr, 31rl for the front right wheel 23fr and the rear left wheel 23rl through the passage 26f and that the fluid pressure sent out from the fluid pressure chamber 25r is supplied to the wheels cylinders 30fl, 30rr of the brake means 31fl, 31rr for the front left wheel 23fl and the rear right wheel 23rr through the passage 26r. In the case of the hydraulic circuit arrangement in the X-letter formation, the controlled hydraulic brake force generating device 43 is provided with the fluid pressure proportional control valves 32 for respective systems connected to the wheel cylinders of the brake means for the separate left and right drive wheels, and the fluid pressures controlled by the respective fluid pressure proportional control valves 32 are supplied respectively to the wheel cylinders for the left and right drive wheels. With this arrangement, when a difference is made between the slip amounts of the left and right drive wheels, the fluid pressure is supplied from the fluid pressure generating device to the wheel cylinder of a drive wheel larger in the slip amount, and the fluid pressure is controlled by the fluid pressure proportional control valve 32 in dependence on the slip amount so that the brake means 31 generates the hydraulic brake force on the drive wheel which is larger in the slip amount. Thus, the vehicle stability control can be accomplished.

Although in the foregoing third embodiment, the vacuum booster 27 is employed as the booster device, it may be substituted by a hydraulic booster which accumulates the pump-generated fluid pressure in an accumulator and which boosts the braking manipulation force acting on the brake pedal 20 by applying the fluid pressure to a piston thereof.

Also although in the foregoing third embodiment, the vehicle brake device is applied to the hybrid car, it may be applied to an electric car.

Various features and many of the attendant advantages in the foregoing third embodiment will be summarized as follows:

In the vehicle brake device in the foregoing third embodiment typically shown in FIGS. 1, 2, 11 and 12, the regeneration cooperative control can be realized by combining the hydraulic brake device 11 which has been existence heretofore, with the regenerative brake device 12. Further, upon occurrence of the variation of the regenerative brake force, the variation detecting means (step S9) detects the variation of an actual regenerative brake force actually generated by the regenerative brake device 12, the brake force compensating means(step S12) generates the controlled fluid pressures through driving the pumps 38 of the hydraulic brake device 11 and through controlling the solenoid fluid pressure proportional control valves 32 to compensate for the lack of the regenerative brake force due to the variation which is detected by the variation detecting means (step S9). At this time, since the boosting ratio (18 in FIG. 11) of the booster device 27 is low when the braking manipulation force (F) is in the low range, the sharing ratio of the regenerative brake force to the target brake force which is to be generated on the wheels 23 in dependence on the braking manipulation force becomes high, so that the energy efficiency can be enhanced. When the braking manipulation force (F) exceeds the low range, the boosting ratio of the booster device 27 becomes high, and the increase rate of the base fluid pressure supplied from the master cylinder 25 to the wheel cylinders 30 becomes large. Thus, it can be realized to make the wheels 23 generate the controlled hydraulic brake force which compensates for the lack of the regenerative brake force due to the detected variation.

In the vehicle brake device in the foregoing third embodiment typically shown in FIG. 11, the same effects as described immediately above can be attained by the simplified construction of the two-step servo (18 in FIG. 11) that the approximately straight line regulating the boosting ratio in the low range is bent in an upward direction when the braking manipulation force (F) exceeds the low range.

In the vehicle brake device in the foregoing third embodiment typically shown in FIGS. 1 and 11, the position at which the line indicating the boosting ratio (18 in FIG. 11) is bent is regulated in dependence on the capability of the regenerative brake device 12 in generating the regenerative brake force, so that the regeneration efficiency can be enhanced. Further, since the burden on the pumps 38 is relieved, the feeling at the braking operation can be improved.

In the vehicle brake device in the foregoing third embodiment typically shown in FIGS. 1 and 13, when the stepping speed of the brake pedal 20 is average, the boosting ratio of the booster device 27 is kept to be low in accordance with the first boosting property (50 in FIG. 13). Thus, the sharing ratio of the regenerative brake force to the target brake force is heightened to improve the energy efficiency. At the emergency braking having a quick stepping speed, the boosting ratio of the booster device 27 is heightened in accordance with the second boosting property (51 in FIG. 13), so that it can be realized to make the wheels 23 to generate a strong base hydraulic brake force quickly.

In the vehicle brake device in the foregoing third embodiment typically shown in FIGS. 1 and 14, since the boosting ratio of the booster device 27 is low when the stepping speed of the brake pedal 20 is average and when the braking manipulation force (F) is in the low range, the sharing ratio of the regenerative brake force to the target brake force which is to be generated on the wheels 23 in dependence on the braking manipulation force (F) is heightened to improve the energy efficiency. Since the boosting ratio of the booster device 27 is heightened when the stepping speed of the brake pedal 20 is average and when the braking manipulation force (F) exceeds the low range, the increase rate of the base fluid pressure supplied from the master cylinder 25 to the wheel cylinders 30 is increased, so that the controlled hydraulic brake force to compensate for the lack of the regenerative brake force due to the detected variation can be generated on the wheels 23 quickly.

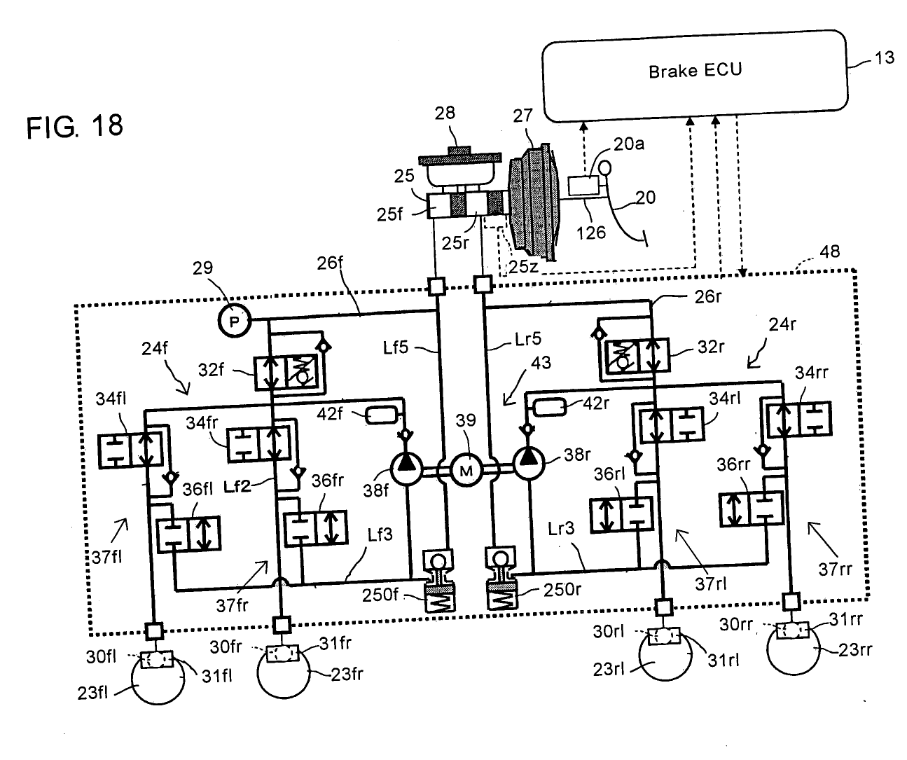

In the vehicle brake device in the foregoing third embodiment typically shown in FIGS. 1, 11 and 14, the same effects as described immediately above can be attained with the simplified construction that the booster device 27 is made to be of the two-step servo (18 in FIG. 11, 52 in FIG. 18).

### Fourth Embodiment

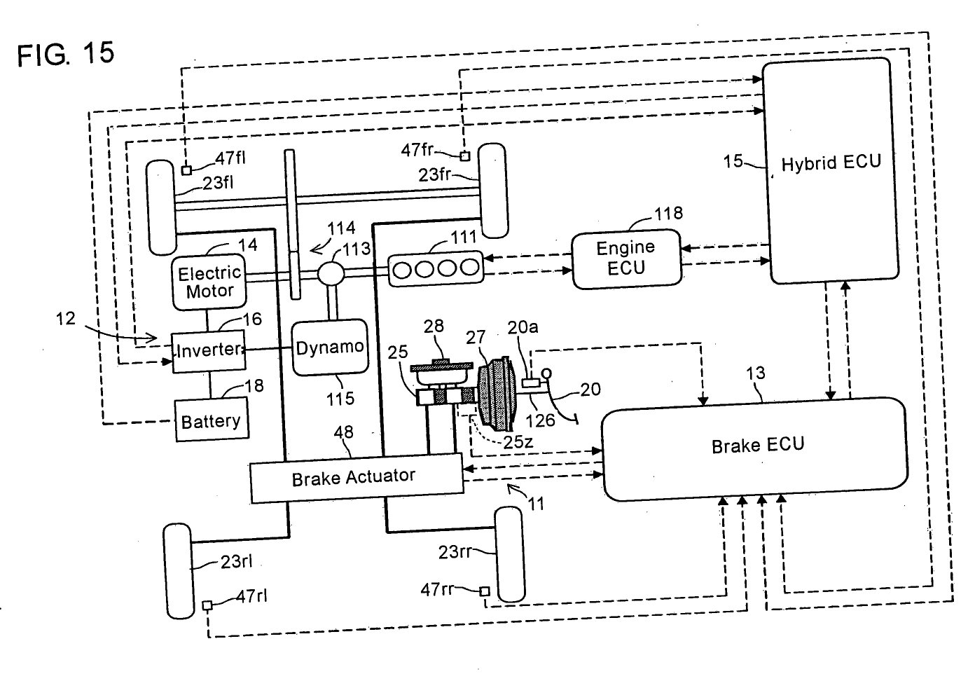

A vehicle brake device in a fourth embodiment according to the present invention is designed for a hybrid vehicle as shown in FIGS. 15. While being illustrated in a way somewhat different from that shown in FIG. 1 in the foregoing first embodiment, the system construction in the present fourth embodiment shown in FIG. 15 has a system circuit diagram which is very similar to that shown in FIG. 1 of the foregoing first embodiment, and unless described to the contrary, the components shown in FIG. 15 have the same functions and the same effects respectively as those shown in FIG. 1 which are identical therewith in reference numerals or symbols. Therefore, for brevity, description hereinafter will be directed to the respects which differ from the foregoing first embodiment.

Referring now to FIG. 15, there is illustrated a hybrid vehicle which is of the type that a hybrid system is employed for driving drive wheels such as front left and right wheels 23fl, 23fr. The hybrid system is a powertrain which uses power sources of two kinds composed of an engine 111 and an electric motor 14 in combination. In the fourth embodiment shown in FIG. 15, there is used a parallel hybrid system which is a driving method of directly driving the front wheels 23f by both of the engine 111 and the electric motor 14. Besides this system, a serial hybrid system is known, in which the wheels are driven by an electric motor with an engine working for an electric power supply to the electric motor.

The hybrid vehicle incorporating the parallel hybrid system is provided with the engine 111 and the electric motor 14. The drive power of the engine 111 is transmitted to the drive wheels (i.e., front left and right wheels 23fl, 23fr in the present fourth embodiment) by way of a drive power splitting mechanism 113 and a drive power transmission gear train 114, while the drive power of the electric motor 14 is transmitted to the drive wheels 23f by way of the drive power transmission gear train 114. The drive power splitting mechanism 113 properly divides the drive power of the engine 111 to a vehicle drive power and a dynamo or generator drive power. The drive power transmission gear train 114 properly unifies the drive powers from the engine 111 and the electric motor 14 in dependence on the vehicle traveling condition and transmits the unified drive power to the drive wheels 23f. The drive power transmission gear train 114 adjusts the drive power ratio of the engine 111 to the electric motor 14 in a range of a 0 to 100 ratio through a 100 to 0 ratio. The drive power transmission gear train 114 is given a speed changing function.

The electric motor 14 is provided on one hand for assisting the engine 111 thereby to enhance the drive power to the drive wheels 23f and on the other hand for performing power generation to charge a battery 18 at the time of vehicle braking. A dynamo 115 is provided for performing power generation upon receiving the output from the engine 111 and is provided with a starter function for engine start. These motor 14 and the dynamo 115 are electrically connected to an inverter 16. The inverter 16 is electrically connected to the battery 18 as a direct current source and is operable for converting an alternate current from each of the motor 14 and the dynamo 115 into a direct current voltage to supply the same to the battery 18 and for reversely converting the direct current voltage from the battery 18 into an alternate current to output the same to the electric motor 14 and the dynamo 115.

In the present fourth embodiment, the motor 14, the inverter 16 and the battery 18 constitute a regenerative brake device 12, which is operable for causing either of the front wheels or the rear wheels (i.e., the front left and right wheels 23fl, 23fr driven by the electric motor 14 as drive source in the present fourth embodiment) to generate a generative brake force depending on a braking manipulation state referred to later which is detected by a pedal stroke sensor 20a (or a pressure sensor 29 shown in FIG. 18).

The engine 111 is controllable by an engine ECU (Electric Control Unit) 118 and, in accordance with an engine output demand value output from a hybrid ECU (Electronic Control Unit) 15 referred to later, the engine ECU 118 outputs an opening-degree command to an electronically controllable throttle thereby to control the rotational speed of the engine 111. The hybrid ECU 15 is connected to the inverter 16 for mutual communication. The hybrid ECU 15 derives demanded values for engine output, electric motor torque and dynamo torque from the gas pedal opening degree and a shift position (which is calculated from a shift position signal input from a shift position sensor, not shown), controls the drive power of the engine 111 by sending the derived engine output demand value to the engine ECU 118, and controls the electric motor 14 and the dynamo 115 through the inverter 16 in accordance respectively with the derived electric motor torque demand value and the derived dynamo torque demand value. Further, the hybrid ECU 15 is also connected to the battery 18 and watches the charged state and the charged electric current of the battery 18. Furthermore, the hybrid ECU 15 is connected to a gas pedal opening-degree sensor (not shown) which is incorporated in a gas pedal (not shown) for detecting the gas pedal opening-degree of the vehicle and has input thereto a gas pedal opening-degree signal from the gas pedal opening-degree sensor.

The hybrid vehicle is also provided with a hydraulic brake device 11 for directly applying a hydraulic brake force to each of the wheels 23 thereby to brake the vehicle. The hydraulic brake device 11 is constructed as shown in FIG. 18. The hydraulic brake device 11 shown in FIG. 18 has substantially the same circuit construction as that shown in FIG. 2, except for the following respects. That is, without passing through a pair of check valves as used in the hydraulic brake device 11 shown in FIG. 2, the inlet ports of the pumps 38 in the fourth embodiment are connected to intermediate portions between the outlet ports of the solenoid shut-off valves 36f, 36r of the ABS control valves 37f, 37r and pressure regulating reservoirs 250f, 250r, respectively. Although in the hydraulic brake device 11 shown in FIG. 2, the conduits or passages and the solenoid shut-off valves 46f, 46r thereon are provided to interconnect the inlet ports of the pumps 38 respectively with the inlet ports of the solenoid fluid pressure proportional control valves 32, they are removed from the hydraulic brake device 11 in the fourth embodiment shown in FIG. 18, and instead, passages Lf5, Lr5 are provided to interconnect the pressure regulating reservoirs 250f, 250r respectively with the conduits (fluid passages) 26f, 26r, as referred to later in detail. In the fourth embodiment, a controlled hydraulic brake force generating device 43 is constituted by the brake actuator 48 which is provided to be encircled by the dotted line between the master cylinder 25 and the wheel cylinders 30, and a base hydraulic brake force generating device is constituted by the brake pedal 20, the vacuum booster 27, the master cylinder 25 and the reservoir or reservoir tank 28.

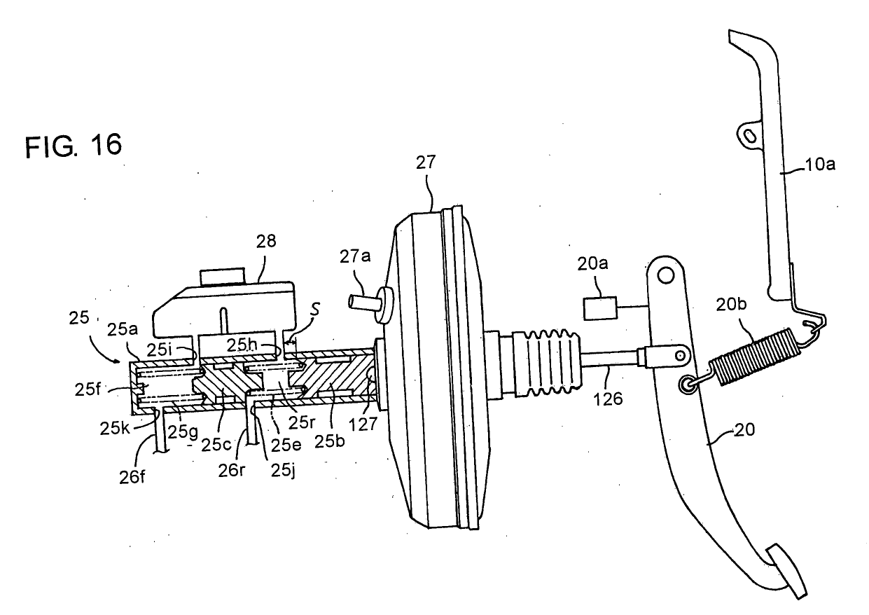

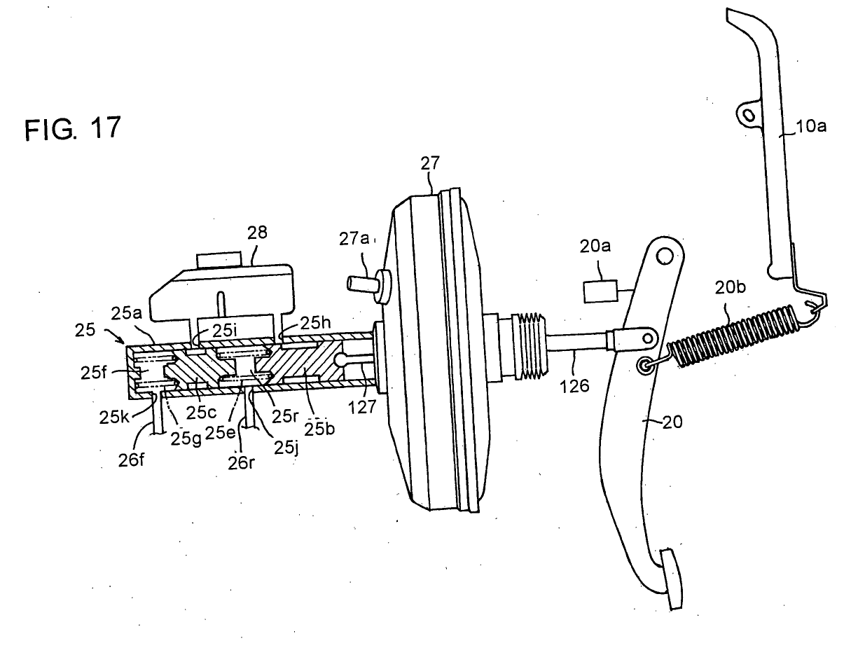

As shown in FIGS. 16 and 17, the brake pedal 20 is connected to the vacuum booster 27 through an operating rod 126, and the vacuum booster 27 is connected to the master cylinder 25 through a push rod 127. The braking manipulation force applied on the brake pedal 20 is input to the vacuum booster 27 through the operating rod 126 to be boosted, and the boosted braking manipulation force is input to the master cylinder 25 through the push rod 127.

The brake pedal 20 is provided with a pedal stroke sensor 20a for detecting a brake pedal stroke indicating the braking manipulation state that the brake pedal 20 is stepped on. The pedal stroke sensor 20a is connected to the brake ECU 13 to transmit its detection signal to the brake ECU 13. Further, the brake pedal 20 is provided with a reaction force spring 20b which is pedal reaction force applying means for applying a pedal reaction force to the brake pedal 20 until the braking manipulation state reaches a predetermined state referred to later. The reaction force spring 20b is connected at its one end to a bracket 10a secured to the vehicle body and urges the brake pedal 20 in a stepping release direction which is a direction opposite to the stepping direction (i.e., in a direction to return the brake pedal 20 to its home position). The urging force of the reaction force spring 20b is desirably determined in taking into consideration the internal diameter of a housing 25a of the master cylinder 25, the boosting ratio and the like.

The vacuum booster 27 is generally well known and communicates at its vacuum inlet port 27a with an intake manifold of the engine 111 to utilize the vacuum in the intake manifold as a boosting power source.

As shown in FIGS. 16 and 17, the master cylinder 25 constituting the base hydraulic brake force generating device is a tandem master cylinder, which is composed of a housing 25a in the form of a bottomed cylinder, first and second pistons 25b, 25c received to be fluid-tightly and slidable within the housing 25a in a tandem fashion, a first spring 25e arranged in a first fluid pressure chamber 25r formed between the first piston 25b and the second piston 25c, and a second spring 25g arranged in a second fluid pressure chamber 25f formed between the second piston 25c and a closed bottom of the housing 25a. Thus, the second piston 25c is urged by the second spring 25g toward an open end side (toward the first piston 25b), and the first piston 25b is urged by the first spring 25e toward the open end side, whereby one end (open end side end) of the first piston 25b is pressured on and brought into contact with an end of the push rod 127.

The housing 25a of the master cylinder 25 is provided with a first port 25h making the first fluid pressure chamber 25r communicate with the reservoir tank 28 and a second port 25i making the second fluid pressure chamber 25f communicate with the reservoir tank 28. When the first piston 25b is at a fist position (returned position, namely the illustrated position in FIG. 16) which is the state that the driver's foot is not on the brake pedal 20, namely the state that the brake pedal 20 is not stepped in, the first port 25h is arranged at a second position which corresponds to the aforementioned predetermined state to be distanced by a predetermined distance (s) from a closing end of the first piston 25b for closing the first port 25h in a pressure increasing direction (in a direction toward the closed bottom side, namely, in the leftward direction in FIG. 16). Similarly, when the second piston 25c is at a first position (returned position, namely the illustrated position in FIG. 16), the second port 25i is arranged at a position where a closing end of the second piston 25c for closing the second port 25i is in alignment with an open end of the second port 25i (i.e., a position immediately before the closing end of the second piston 25c begins to close the opening of the second port 25i).

It is to be noted that the aforementioned predetermined state is a braking manipulation state wherein the restriction on the generation of the base hydraulic brake force is released and wherein the base hydraulic brake force begins to increase in correspondence to the braking manipulation state. The predetermined distance (s) is desirably set to make the regenerative brake device 12 to generate the maximum regenerative brake force when the braking manipulation state is the predetermined state. Thus, when the braking manipulation state turns into the predetermined state, the master cylinder 25 is released from the restriction on the generation of the base hydraulic brake force, and the regenerative brake device 12 generates the maximum regenerative brake force.

Further, the housing 25a of the master cylinder 25 is provided with a third port 25j which makes the first fluid pressure chamber 25r communicate with the conduit (fluid passage) 26r constituting the rear brake system 24r and a fourth port 25k which makes the second fluid pressure chamber 25f communicate with the conduit (fluid passage) 26f constituting the front brake system 24f. As shown in FIG. 18, the conduit 26r makes the first fluid pressure chamber 25r communicate with wheel cylinders 30rl, 30rr of the rear left and right wheels 23rl, 23rr, and the conduit 26f makes the second fluid pressure chamber 25f communicate with wheel cylinders 30fl, 30fr of the front left and right wheels 23fl, 23fr.

The operation of the aforementioned master cylinder 25 will be described with reference to FIGS. 16 and 17. As shown in FIG. 16, in the state that the brake pedal 20 is not being stepped, the operating rod 126 and the push rod 127 are not being pushed and not moved. Thus, the first piston 25b and the second piston 25c are not pushed, whereby a base fluid pressure is not generated in the first and second fluid pressure chambers 25r, 25f.

However, when the brake pedal 20 in the state of being not stepped as shown in FIG. 16 is stepped on by the driver, the operating rod 126 and the push rod 127 are pushed, and thus, the first piston 25b is pushed. At this time, the closing end of the first piston 25b does not begin to close the first port 25h until the first piston 25b pushed by the push rod 127 is moved beyond the predetermined distance (s) in the leftward direction as viewed in the figure (in the pressure increasing direction). Thus, since the brake fluid in the first fluid pressure chamber 25r is allowed to flow into the reservoir tank 28 through the first port 25h, the base fluid pressure is not generated in the first fluid pressure chamber 25r. Further, since the base fluid pressure is not generated in the first fluid pressure chamber 25r while the movement of the first piston 25b causes the first spring 25e to be compressed, the second piston 25c is not pushed toward the leftward direction as viewed in the figure (in the pressure increasing direction) and remains stopped at the first position. Thus, since the closing end of the second piston 25c does not begin to close the second port 25i, the base fluid pressure is not generated in the second fluid pressure chamber 23f either.

When the first piston 25b is moved by the distance which is made by adding the diameter of the first port 25h to the predetermined distance (s), in the leftward direction as viewed in the figure, the first port 25h is closed by the closing end of the first piston 25b. Thus, since the brake fluid in the first fluid pressure chamber 25r becomes unable to be discharged into the reservoir tank 28 through the first port 25h, the first fluid chamber 26r is brought into a closed state, whereby the base fluid pressure begins to be generated in the first fluid pressure chamber 25r. Further, since the second piston 25c is pushed in the leftward direction as viewed in the figure upon receipt of the base fluid pressure generated in the first fluid pressure chamber 25r thereby to make its closing end close the second port 25i instantly, the brake fluid in the second fluid pressure chamber 25f becomes unable to be discharged into the reservoir tank 28 through the second port 25i, and the second fluid chamber 25f is brought into a closed state, whereby the base fluid pressure begins to be generated also in the second fluid pressure chamber 25f.

In this way, when a stepping-in state shown in FIG. 17 is reached as the result that the brake pedal 20 is further stepped in from the state that the base fluid pressure begins to be generated in the first and second fluid pressure chambers 25r, 25f, the base fluid pressure depending on the braking manipulation state is generated in the first and second fluid pressure chambers 25r, 25f during the period which continues from a base fluid pressure generation starting state to the stepping-in state shown in FIG. 17. The first and second fluid pressure chambers 25r, 25f are designed to generate the same base fluid pressures therein. When the brake pedal 20 is released from the stepping-in state shown in FIG. 17, the first and second pistons 25b, 25c are returned to their home positions (the respective first positions) by means of urging forces of the first and second springs 25e, 25g and upon receipt of the pressures in the conduits 26r, 26f.

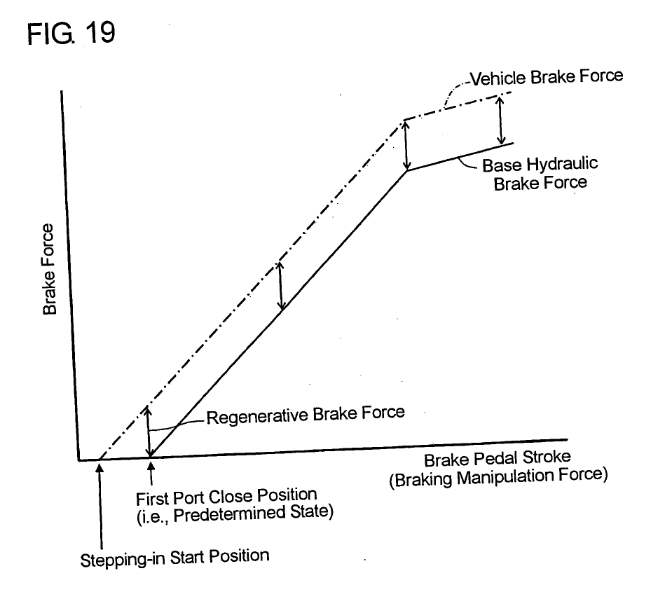

A base hydraulic brake force depending on the base fluid pressure generated in the master cylinder 25 is varied as indicated by the solid line in FIG. 19. That is, when the brake pedal stroke is between the stepping start position and the position to close the first port 25h, the base fluid pressure generated in the first and second fluid pressure chambers 25r, 25f is restricted to zero, so that the generation of the base hydraulic brake force is restricted to zero. Then, when the brake pedal stroke is beyond the position to close the first port 25h, the aforementioned restriction on the generation of the base fluid pressure is released to make the first and second fluid pressure chambers 25r, 25f generate the base fluid pressure corresponding to the brake pedal stroke, so that the base hydraulic brake force is generated in correspondence to the brake pedal stroke. The state that the brake pedal stroke reaches the position to close the first port 25h is the aforementioned predetermined state and the aforementioned braking manipulation state that the base hydraulic brake force begins to increase in correspondence to the brake pedal stroke. Accordingly, as indicated by the solid line in FIG. 19, the base hydraulic brake force corresponding to the base fluid pressure can be generated on the wheels 23 by directly applying the base fluid pressure to the wheel cylinders 30.

The brake actuator 48 shown in FIG. 18 is generally well known and is constructed to package, in a case, solenoid fluid pressure proportional control valves 32f, 32r, ABS control valves 37fl, 37fr, pressure regulating reservoirs 250f, 250r, pumps 38f, 28r, an electric motor 39 and the like. The ABS control valves 37fl, 37fr are composed of pressure increasing control valves 34fl, 34fr, 34rl and 34rr and pressure reducing control valves 36fl, 36fr, 36rl, 36rr. As mentioned earlier, the brake actuator 48 in the fourth embodiment shown in FIG. 18 is different from that 48 in the first embodiment shown in FIG. 2 in the following respects. That is, without passing through a pair of check valves as used in the hydraulic brake device 11 shown in FIG. 2, the inlet ports of the pumps 38 in the fourth embodiment are connected to intermediate portions between the outlet ports of the solenoid shut-off valves 36f, 36r of the ABS control valves 37f, 37r and the pressure regulating reservoirs 250f, 250r, respectively. Although in the hydraulic brake device 11 shown in FIG. 2, the passages and the solenoid shut-off valves 46f, 46r thereon are provided to interconnect the inlet ports of the pumps 38 respectively with the inlet ports of the solenoid fluid pressure proportional control valves 32, they are removed from the hydraulic brake device 11 in the fourth embodiment shown in FIG. 18, and instead, passages Lf5, Fr5 are provided to interconnect the pressure regulating reservoirs 250f, 250r respectively with the conduits 26r, 26f, as referred to later in detail. In the fourth embodiment, a controlled hydraulic brake force generating device is constituted by the brake actuator 48 which is provided to be encircled by the dotted line between the master cylinder 25 and the wheel cylinders 30, and a base hydraulic brake force generating device is constituted by the brake pedal 20, the vacuum booster 27, the master cylinder 25 and the reservoir tank 28.

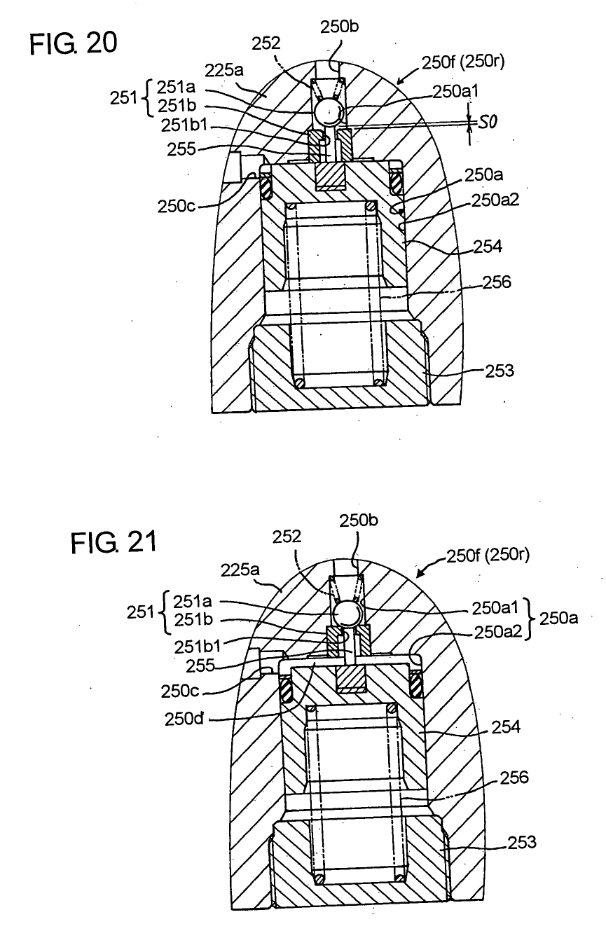

Further, the construction of the pressure regulating reservoirs 250f, 250r will be described with reference to FIGS. 20 and 21. As shown in FIG. 20, the pressure regulating reservoirs 250f, 250r are of the same construction and are built in a housing 225a of the brake actuator 48. For the pressure regulating reservoirs 250f, 250r, the housing 225a has formed therein two stepped holes 250a each composed of a small-diameter hole 250a1 and a large-diameter hole 250a2. One end (upper end of the small-diameter hole 250a1 is formed with a reservoir hole 250b communicating with one end of the aforementioned fluid passage Lf5 (or Lr5) whose the other end communicates with the master cylinder 25, and a pressure regulating valve 251 is arranged at the other end (lower end) of the small-diameter hole 250a1. The pressure regulating valve 251 is composed of a ball valve 251a as valve member and a valve seat 251b having a valve hole 251b1. The ball valve 251a is urged by the resilient force of a spring 252 toward the valve seat 251b thereby to close the valve hole 251b1, as shown in FIG. 21.

One end (upper end) of the large-diameter hole 250a2 is formed with a reservoir hole 250c communicating with one end of a fluid passage Lf3 (or Lr3) which communicates with the inlet port of the pump 38f (or 38r) and the outlet ports of the pressure reducing shut-off valves 36f (or 36r), and a plug member 253 is secured to the other end of the large-diameter hole 250a2 thereby to close an opening portion of the same. A piston 254 is received in the large-diameter hole 250a2 fluid-tightly and slidably. One end surface (top surface) of the piston 254 has bodily secured thereto a pin 255 which is reciprocatively movable in the valve hole 251b1 of the valve seat 251b and which is contactable at its protruding end portion with the ball valve 251a thereby to move the ball valves 251a vertically.

The piston 254 is pushed by means of the resilient force of a spring 256 (which is set to be larger than the resilient force of the spring 252) arranged between itself and the plug member 253, toward one end side (in the upward direction) and is brought into contact with an upper end surface of the large-diameter hole 250a2, as shown in FIG. 20. Since the end of the pin 255 is set to be protruded by a predetermined amount (S0) from the valve seat 251b in this state, the ball valve 251a is able to move by the predetermined amount (S0) relative to a seat surface of the valve seat 251b. A reservoir chamber 250d storing the brake fluid is provided between the pressure regulating valve 251 and the piston 254 in the stepped hole 250a.

As described above, the pressure regulating reservoir 250f (250r) is constructed so that the end of the pin 255 pushes the ball valve 251a to open the valve hole 251b1 when the brake fluid stored in the reservoir chamber 250d is less than a predetermined volume (i.e., the amount corresponding to the stroke of the predetermined amount (S0)), but the valve hole 251b1 is closed by means of the ball valve 251a when the reservoir chamber 250d is filled with the brake fluid of the predetermined volume, as shown in FIG. 21. The operation of the pressure regulating reservoir 250f (250r) will be described hereinafter.

First of all, when the master cylinder pressure (base fluid pressure) is not generated with the brake pedal 20 being not stepped in and when the controlled fluid pressure is not generated with the brake actuator 48 being not operated, the piston 254 of the pressure regulating reservoir 250f (250r) urged by the resilient force of the spring 256 is brought at its top surface into contact with the upper end surface of the large-diameter hole 250a2, whereby the ball valve 251a is positioned to be higher by the predetermined amount (S0) than the seat surface of the valve seat 251b, as shown in FIG. 20.

At the time of an ordinary or average braking wherein the driving of the pumps 38f, 38r is not performed, the solenoid fluid pressure proportional control valves 32f, 32r and the pressure increasing control valves 34fl, 34fr, 34rl, 34rr are kept in the open state with the pressure reducing control valves 36fl, 36fr, 36rl, 36rr remaining in the closed state. Thus, the master cylinder pressure which is generated by the stepping-in of the brake pedal 20 is applied to the wheel cylinders 30fl, 30fr, 30rl, 30rr. At this time, the brake fluid from the master cylinder 25 is flown into the reservoir chambers 250d through the fluid passages Lf5, Lr5, the reservoir holes 250b and the valve holes 251b1. However, when with the increase of the flown volume, the pistons 254 are pushed down by the predetermine amount (S0) against the resilient force of the springs 256, the balls 251a supported on the pins 255 are moved to be pressured on the valve seats 251b to close the valve holes 251b1, as shown in FIG. 21. In this way, provision is made not to apply the master cylinder pressure to the inlet ports of the pumps 38f, 38r. Although the master cylinder pressure (base fluid pressure) corresponding to the braking manipulation state is directed and applied to the wheel cylinders 30fl, 30fr, 30rl, 30rr when the pressure regulating valves 251 begin to be closed, the brake fluid from the master cylinder 25 is flown into the reservoir chambers 250d through the pressure regulating valves 251 until the same come to be closed. Thus, the base fluid pressure corresponding to the braking manipulation state is not applied to the wheel cylinders 30fl, 30fr, 30rl, 30rr until the pressure regulating valves 251 are closed. However, since the predetermined amount is quite minute, a large influence is not given on the generation of the base fluid pressure.

For example, where the brake fluid pressure (controlled fluid pressure) is to be generated to assist the stepping-in of the brake pedal 20, the solenoid fluid pressure proportional control valves 32f, 32r are brought to generate the pressure difference there across. Thus, brake fluids from the conduits 26f, 26r are flown into the reservoir chambers 250d through the fluid passages Lf5, Lr5 and the reservoir holes 250b. Then, the brake fluids in the reservoir chambers 250d are drawn by the pumps 38f, 38r to be supplied to the fluid passages connected to the outlet ports of the pumps 38f, 38r, and the pressures in the wheel cylinders 30fl, 30fr, 30rl, 30rr are kept by the solenoid fluid pressure proportional control valves 32f, 32r to be higher than that in the master cylinder 25. Where the drawing capability of the pumps 38f, 38r cannot follow the brake fluid volumes flown into the reservoir chambers 250d to let the brake fluids of a predetermined volume remain in the reservoir chambers 250d (also as is the case of the reduction of the wheel cylinder pressures under the ABS control), the ball valves 251a are seated on the valve seats 251b to block the conduits 26f, 26r (master cylinder 25) from the inlet sides of the pumps 38f, 38r. Then, the brake fluids in the reservoir chambers 250d are drawn by the pumps 38f, 38r, and the brake fluid volumes in the reservoir chambers 250d are decreased, whereby the pins 255 push the ball valves 251a up to supply the brake fluid from the master cylinder 25 to the reservoir chambers 250d.

Further, as shown in FIG. 15, the vehicle brake device is provided with the brake ECU (Electronic Control Unit) 13 which has connected thereto the pedal stroke sensor 20a, wheel speed sensors 47fl, 47fr, 47rl, 47rr for respectively detecting the wheel speeds of the respective wheels 23, the pressure sensor 29, the control valves 32f, 32r, 34fl, 34fr, 34rl, 34rr, 36fl, 36fr, 36rl, 36rr and the electric motor 39. The brake ECU 13 executes the switching controls or the current control of the open/close motions of the respective valves 32f, 32r, 34fl, 34fr, 34rl, 34rr, 36fl, 36fr, 36rl, 36rr in the hydraulic brake device 11 in dependence on the detection signals of the respective sensors and the state of a shift switch for controlling the controlled fluid pressures to be applied the wheel cylinders 30fl, 30fr, 30rl, 30rr, that is, the controlled hydraulic brake forces to be generated on the respective wheels 23fl, 23fr, 23rl, 23rr.

Further, the brake ECU 13 is connected with the hybrid ECU 15 for mutual communication therebetween, wherein a cooperative control between the regenerative braking performed by the motor 14 and the hydraulic braking is performed to make the total brake force of the vehicle equivalent to that of the vehicle which attains the total brake force by hydraulic brake only. More specifically, the brake ECU 13 is responsive to the brake demand of the driver or to the braking manipulation state and outputs to the hybrid ECU 15 a regeneration demand value which of the total brake force, is the portion to be undertaken by the regenerative brake device 12, as a target value for the regenerative brake device, namely, as a target regenerative brake force. The hybrid ECU 15 derives an actual generation execution value to be actually applied as the regenerative brake, based on a regeneration demand value (target regenerative brake force) input thereto and also taking into account the vehicle speed, the charged state of the battery 18, and the like. The hybrid ECU 15 then controls through the inverter 16 the motor 14 to generate the regenerative brake force corresponding to the actual regeneration execution value and also outputs the derived actual regeneration execution value to the brake ECU 13.

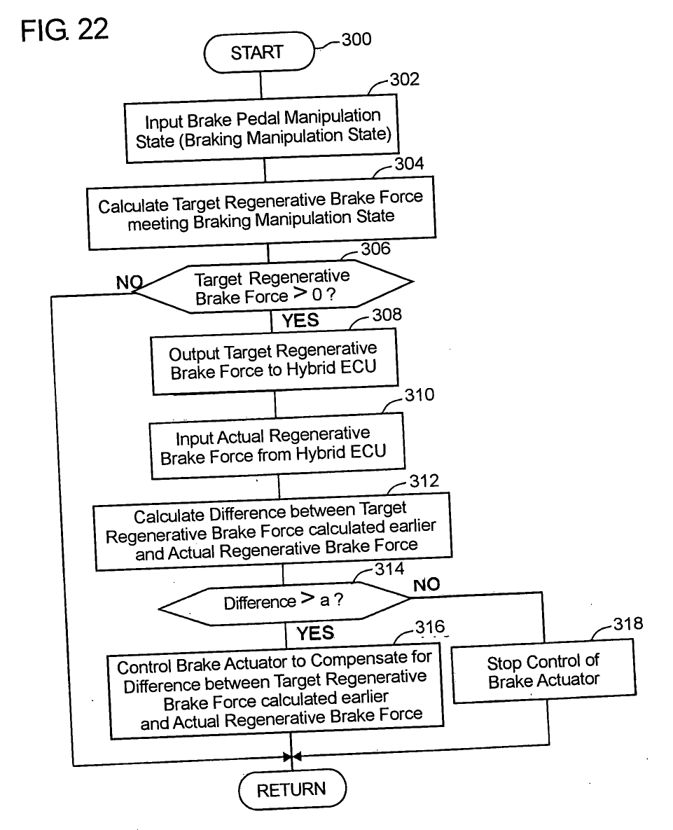

Further, the brake ECU 13 stores various base hydraulic brake forces which the brake means 31 selectively applies to the wheels 23 when a base fluid pressure is supplied to the wheel cylinders 30, in a memory in the form of a map, table or arithmetic expression. Also, the brake ECU 13 stores various target regenerative brake forces which are to be selectively applied to the wheels 23 independence on the braking manipulation state detected as the stroke of the brake pedal 20 (or as the master cylinder pressure), in the memory in the form of another map, table or arithmetic expression. Further, the brake ECU 13 stores a cooperative control program (vehicle brake control program) shown in FIG. 22.

Next, the operation of the vehicle brake device as constructed above will be described in accordance with a flow chart shown in FIG. 22. The brake ECU 13 executes a program corresponding to the flow chart at a predetermined minute time interval when an ignition switch (not shown) of the vehicle is in ON state. The brake ECU 13 takes thereinto a pedal stroke representing the manipulating state of the brake pedal 20, from the pedal stroke sensor 20a (step 302) and calculates a target regenerative brake force corresponding to the input pedal stroke (step 304: target regenerative brake force calculating means). At this time, the brake ECU 13 uses the map, table or arithmetic expression which has been stored in advance for showing the correlation between the pedal stroke or the braking manipulation state and the target regenerative brake force to be applied to the wheels 23fl, 23fr, 23rl, 23rr.

When the target regenerative brake force is larger than zero, the brake ECU 13 outputs the target regenerative brake force calculated at step 304 to the hybrid ECU 15 and does not execute the control of the brake actuator 48 (steps 306 and 308). Thus, when the brake pedal 20 is being stepped on, as is the aforementioned case, the hydraulic brake device 11 applies the base hydraulic brake force (static pressure brake) only to the wheels 23fl, 23fr, 23rl, 23rr. Further, the hydraulic ECU 15 has input thereto a regeneration demand value representing the target regenerative brake force, controls the electric motor 14 through the inverter 16 so that the regenerative brake force can be generated based on the regeneration demand value and taking the vehicle speed, the charged state of the battery, and the like into consideration, and outputs the actual regeneration execution value to the brake ECU 13. Accordingly, when the braking manipulation is being performed and when the target regenerative brake force is larger than zero, the regenerative brake force together with the base hydraulic brake force is additionally applied to the front wheels 23fl, 23fr. Although the regeneration cooperative control is executed in this manner, the base hydraulic brake force and the regenerative brake force are in dependence on the braking manipulation force, and one example for this dependence is shown in FIG. 19. FIG. 19 shows the correlation in which the sum of the base hydraulic brake force and the regenerative brake force is indicated in connection with the braking manipulation force under the regeneration cooperative control.

That is, at the time of the stepping-in of the brake pedal 20, the master cylinder 25 (base fluid pressure force generation restricting means) in the fourth embodiment restricts the generation of the base hydraulic brake force to a predetermined value or less until the braking manipulation state is varied from a stepping-in starting state which is the state at the time point of the stepping-in start to the predetermined state. Thus, when the drivers steps on the brake pedal 20, the base hydraulic brake force is compulsorily restricted to the predetermined value or less from the stepping-in starting state until the predetermined state is reached, as shown in FIG. 19. Thus, during this period, the regenerative brake force only is applied in dependence on the braking manipulation state. Further, when the braking manipulation state becomes the predetermined state, the restriction on the generation of the base hydraulic brake force is released, and the regenerative brake device 12 generates the maximum regenerative brake force, whereby the maximum regenerative brake force only is applied. Further, when the braking manipulation state advances to a further stepped-in state beyond the predetermined state, the restriction on the generation of the base hydraulic brake force is kept released, and the hydraulic brake device 11 and the regenerative brake device 12 are cooperatively operated to apply a vehicle brake force which is the sum of the hydraulic brake force and the regenerative brake force (basically, the maximum regenerative brake force) and which corresponds to the braking manipulation state.

The brake ECU 13 detects the variation in the regenerative brake force which has been actually generated by the regenerative brake device 12 (steps 310 to 314). Specifically, the brake ECU 13 at step 310 inputs therein the actual regeneration execution value indicating the actual-regenerative brake force which the regenerative brake device 12 having actually applied to the front wheels 23fl, 23fr in response to the target regenerative brake force calculated at step 304 (step 310: actual regenerative brake force inputting means), calculates the difference between the target regenerative brake force calculated at step 304 and the actual regenerative brake force input at step 310 (step 312: difference calculating means), and detects the occurrence of the variation in the regenerative brake force if the calculated difference is larger than a predetermined value (a) (step 314: judgment means).

Then, when detecting the variation of the regenerative brake force, the brake ECU 13 makes a judgment of YES at step 314 and compensates for the lack of the brake force due to the variation in the regenerative brake force detected as mentioned earlier by generating the controlled fluid pressure while driving the pumps 38f, 38r of the hydraulic brake device 11 and by applying to the wheels 23fl, 23fr, 23rl, 23rr a controlled hydraulic brake force depending on the controlled fluid pressure (step 316). Specifically, the brake ECU 13 controls the controlled fluid pressure to coincide with the difference between the target regenerative brake force calculated at step 304 and the actual regenerative brake force input at step 310, that is, with the difference calculated at step 312. The brake ECU 13 starts the electric motor 39 to drive the pumps 38f, 38r and applies an electric current to linear solenoids (not shown) of the solenoid fluid pressure proportional control valves 32f, 32r so that the fluid pressures of the brake fluids supplied from the pumps 38f, 38r to the wheels cylinders 30fl, 30fr, 30rl, 30rr become the controlled fluid pressures. At this time, it is preferable to perform a feedback control on the linear solenoids so that the fluid pressures in the wheel cylinders 30fl, 30fr, 30rl, 30rr detected by the fluid pressure sensors 40 coincide with the controlled fluid pressure. When not detecting the variation in the regenerative brake force, on the other hand, the brake ECU 13 makes a judgment of NO at step 314 and stops controlling the brake actuator 48 (step 318).

As is clear from the foregoing description, in the fourth embodiment, at the time of the stepping-in of the brake pedal 20, the master cylinder 25 constituting the base hydraulic brake force generation restricting means restricts the generation of the base hydraulic brake force to a predetermined value (e.g., zero) or less until the braking manipulation state (i.e., pedal stroke) is varied from the stepping-in starting state (first position) which is the state at the time point of the stepping-in start to the predetermined state (second position). Thus, when the drivers steps on the brake pedal 20, the base hydraulic brake force is compulsorily restricted to the predetermined value or less from the stepping-in starting state until the predetermined state is reached. During this period, on the other hand, the regenerative brake device 12 compensates for the lack of the base hydraulic brake force in the vehicle brake force through the cooperative operation with the hydraulic brake device 11 in attaining a vehicle brake force corresponding to the braking manipulation state. Accordingly, in the low stepping force range extending from the stepping-in starting state until the predetermined state is reached, the regenerative brake force is positively utilized, so that it can be realized to achieve a high regeneration efficiency and hence, a high fuel efficiency.

Further, when the braking manipulation state (the pedal stroke of the brake pedal 20) reaches the predetermined state (the state wherein the first port 25h of the master cylinder 25 is closed), the master cylinder 25 (base hydraulic brake force generation restricting means) releases the restriction on the generation of the base hydraulic brake force, and the regenerative brake device 12 generates the maximum regenerative brake force, so that the range in which the generation of the base hydraulic brake force is restricted can be secured as long as possible. Accordingly, by delaying the generation of the base hydraulic brake force as long as possible, it can be realized to utilize the regenerative brake force to the maximum and usefully over the whole range during the stepping-in of the brake pedal 20.

Further, the base hydraulic brake-force generation restricting means is constituted by the master cylinder 25, and in the master cylinder 25, the first port 25h which is provided in the first fluid pressure chamber 25r to communicate with the reservoir tank 28 is provided at the second position which corresponds to the aforementioned predetermined state to be distanced by the predetermined distance (s) from the closing end of the first piston 25b for closing the first port 25h in the pressure increasing direction. Thus, it can be realized to restrict the generation of the base hydraulic brake force with the simplified construction.

Further, the hydraulic brake device 11 is constructed so that the controlled hydraulic brake force is able to be generated on the respective wheels 23fl, 23fr, 23rl, 23rr by applying to the respective wheel cylinders 30fl, 30fr, 30rl, 30rr the controlled fluid pressures which are controlled by driving the pumps 38f, 38r and by controlling the solenoid fluid pressure proportional control valves 32r, 32f. And, brake force compensating means (steps 312 to 316 in FIG. 22) is provided, and when the variation of the actual regenerative brake force is detected with the generation of the base hydraulic brake force being restricted by the base hydraulic brake force generation restricting means, the brake force compensating means generates the controlled fluid pressure by driving the pumps 38f, 38r and by controlling the solenoid fluid pressure proportional control valves 32r, 32f and compensates for the lack of the regenerative brake force due to the detected variation by generating on the wheels 23fl, 23fr, 23rl, 23rr the controlled hydraulic brake force depending on the controlled fluid pressure. Thus, regardless of the variation of the regenerative brake force, it can be realized to stably apply the brake force demanded by the driver.

Further, since the braking manipulation state is detected by the pedal stroke sensor (brake pedal stroke sensor) 20a which detects the stroke of the brake pedal 20, the braking manipulation state can be detected reliably and directly by the pedal stroke sensor 20a, and the base hydraulic brake force can be reliably restricted in dependence on the braking manipulation state. Alternatively, the braking manipulation state may be detected by a master cylinder stroke sensor 25z which detects the stroke of the master cylinder 25. The master cylinder stroke sensor 25z is constructed to be able to transmit its detection signal to the brake ECU 13. Also in this modified case, the braking manipulation state can be detected reliably and directly by the master cylinder stroke sensor 25z, and the base hydraulic brake force can be reliably restricted in dependence on the braking manipulation state.

In addition, the reaction force spring 20b is provided as the pedal reaction force applying means for applying a pedal reaction force to the brake pedal 20 until the braking manipulation state reaches the predetermined state. Thus, the driver is given a good pedal feeling until the braking manipulation state reaches the predetermined state after the stepping-in of the brake pedal 20 begins.

### Fifth Embodiment

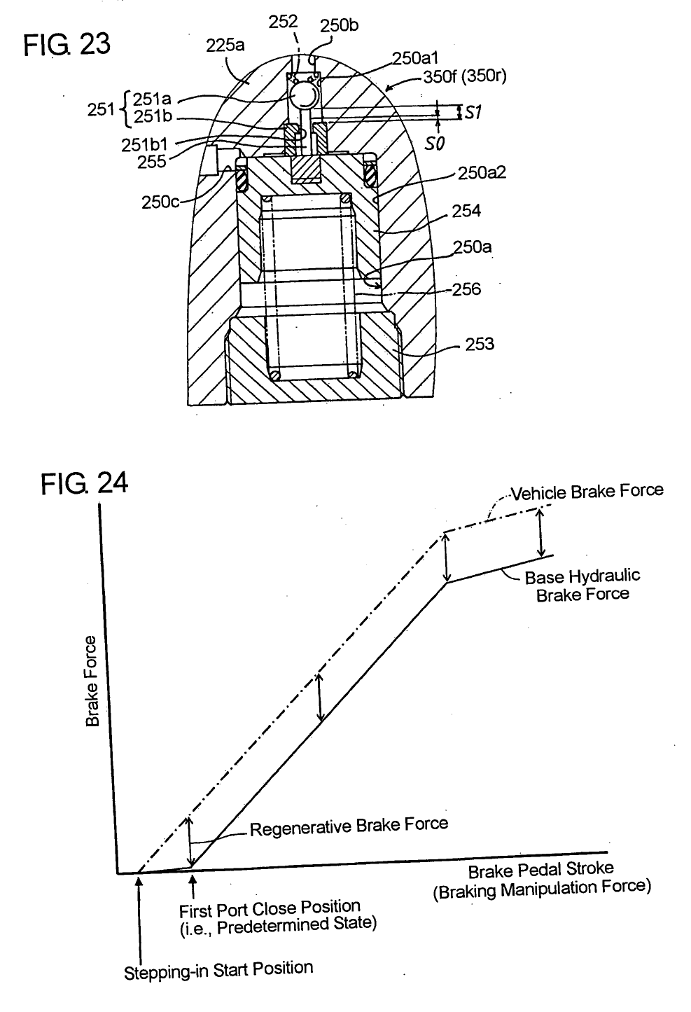

In the foregoing fourth embodiment, the base hydraulic brake force generation restricting means is constituted by the master cylinder 25, and the first port 25h which is provided in the first fluid pressure chamber 25r of the master cylinder 25 to communicate with the reservoir tank 28 is provided at the second position which corresponds to the aforementioned predetermined state to be distanced by the predetermined distance (s) from the first position which corresponds to the stepping-in starting state of the closing end of the first piston 25b for closing the first port 25h, in the pressure increasing direction of the first piston 25b. Alternatively, the base hydraulic brake force generation restricting means may be constituted by pressure regulating reservoirs 350f, 350r which as shown in FIG. 23, are modified from those 250f, 250r shown in FIGS. 20 and 21 to be provided respectively on the fluid passages Lf5, Lr5 in substitution for the pressure regulating reservoirs 250f, 250r. These modified pressure regulating reservoirs 350f, 350r are constituted as fluid pressure admitting sections provided on the fluid passages Lf5, Lr5, and each of the pressure admitting sections restricts the generation of the base hydraulic brake force to less than a predetermined value by admitting the base fluid pressure from the master cylinder 25 until the braking manipulation state is varied from the stepping-in starting state to the predetermined state, and releases the restriction on the generation of the base hydraulic brake force by suppressing the admission of the base fluid pressure from the master cylinder 25 after the braking manipulation state is advanced beyond the predetermined state.

More specifically, as shown in FIG. 23, the modified pressure regulating reservoir 350f (350r) is constructed so that in the stepping-in starting state, the ball valve 251a constituting the pressure regulating valve 251 of the pressure regulating reservoir 350f (350r) takes a position which is distanced by a predetermined distance (S1) in the valve opening direction (in the upward direction) from the valve closing position (shown in FIG. 21) where the ball valve 251a is in contact with the valve seat 251b having the valve hole 251b1, to close the valve hole 251b1 and that in the predetermined state, the ball valve 251a takes the valve closing position. In other words, in the fifth embodiment, the pin 255 is set to be longer by the difference of S1-S0 than that in the foregoing fourth embodiment. Further, like the aforementioned second port 25i, the first port 25h of the master cylinder 25 is arranged so that the closing end of the first piston 25b for closing the first port 25h is positioned to align with the opening end of the first port 25h (i.e., the position immediately before the closing end of the first piston 25b begins to close the first port 25h) when at the first position (returned position: the illustrated state in FIG. 16) wherein the driver's foot is not on the brake pedal 20, namely the brake pedal 20 is not being stepped in.

The operation of the hydraulic brake device 11 and primarily, the operation of the modified pressure regulating reservoir 350f (350r) will be described with reference to FIG. 23. First of all, when the master cylinder pressure (base fluid pressure) is not generated with the brake pedal 20 being not stepped in and when the controlled fluid pressure is not generated with the brake actuator 48 being not operated, the piston 254 of the pressure regulating reservoir 350f (350r) urged by the resilient force of the spring 256 is brought at its top surface into contact with the upper end surface of the large-diameter hole 250a2, whereby the ball valve 251a is positioned to be higher by another predetermined amount (S1) than the seat surface of the valve seat 251b, as shown in FIG. 23.

At the time of an ordinary or average braking wherein the driving of the pumps 38f, 38r is not performed, the solenoid fluid pressure proportional control valves 32f, 32r and the pressure increasing control valves 34fl, 34fr, 34rl, 34rr are kept in the open state with the pressure reducing control valves 36fl, 36fr, 36rl, 36rr remaining in the closed state. Thus, the master cylinder pressure which is generated by the stepping-in of the brake pedal 20 is applied to the wheel cylinders 30fl, 30fr, 30rl, 30rr. At this time, the brake fluid from the master cylinder 25 is flown into the reservoir chambers 250d through the fluid passages Lf5, Lr5, the reservoir holes 250b and the valve holes 251b1. However, when with the increase of the flown volume, the pistons 254 are pushed down by the predetermine amount (S1) against the resilient force of the springs 256, the balls 251a supported on the pins 255 are moved to be pressured on the valve seats 251b to close the valve holes 251b1, in the same manner as shown in FIG. 21. In this way, provision is made not to apply the master cylinder pressure to the inlet ports of the pumps 38f, 38r.

Although the master cylinder pressure (base fluid pressure) corresponding to the braking manipulation state is directly applied to the wheel cylinders 30fl, 30fr, 30rl, 30rr when the pressure regulating valves 251 begin to be closed (i.e., the predetermined state begins to reach), the brake fluid from the master cylinder 25 is flown into the reservoir chambers 250d through the pressure regulating valves 251 until the same come to be closed. Thus, the base fluid pressure corresponding to the braking manipulation state is not applied the wheel cylinders 30fl, 30fr, 30rl, 30rr until the pressure regulating valves 251 is closed. At this time, since the brake fluid is flown into the pressure regulating reservoirs 350f (350r) to generate a fluid pressure which is not as high as the base fluid pressure corresponding to the braking manipulation state, such a fluid pressure is applied to the respective wheel cylinders 30fl, 30fr, 30rl, 30rr.

The solid line in FIG. 24 indicates the base hydraulic brake force depending on the base fluid pressure generated by the hydraulic brake device 11. That is, where the brake pedal stroke is between the stepping-in start position and the position (valve closing state) to close the pressure regulating valves 251, the base fluid pressure generated in the first and second fluid pressure chambers 25f, 25r of the master cylinder 25 corresponds to the braking manipulation state, in which case, however, the opening of the pressure regulating valves 251 allows the generated base fluid pressure to go through the pressure regulating valves 251 to be absorbed in the pressure regulating reservoirs 350f (350r), whereby the base fluid pressure is not applied to the wheel cylinders 30fl, 30fr, 30rl, 30rr. Consequently, the generation of the base hydraulic brake force is restricted. Then, where the brake pedal stroke is beyond the position to close the pressure regulating valves 251, the aforementioned restriction on the generation of the base hydraulic brake force is released to apply to the wheel cylinders 30fl, 30fr, 30rl, 30rr the base fluid pressure generated in the first and second fluid pressure chambers 25f, 25r, so that the base hydraulic brake force comes to correspond to the brake pedal stroke. It is to be noted that the state wherein the pressure regulating valve 251 is at the closing state starting position, namely wherein the ball valve 251a is seated on the valve seat 251b is the aforementioned predetermined state and the braking manipulation state wherein the base hydraulic brake force begins to increase in dependence on the brake pedal stroke. Accordingly, by directly applying the base fluid pressure to the wheel cylinders 30fl, 30fr, 30rl, 30rr as shown in FIG. 24, it can be realized to make the wheels 23fl, 23fr, 23rl, 23rr generate the base hydraulic brake force corresponding to the base fluid pressure. Also in this fifth embodiment, it can be realized to restrict the generation of the base hydraulic brake force with the simplified construction by utilizing the brake actuator (automatic pressuring device) which has been existent heretofore without adding any new device.

Although in the foregoing fifth embodiment, the modified pressure regulating reservoirs 350f (350r) are employed as the fluid pressure admitting sections, other components may be utilized in substitution therefor if they are provided on the fluid passages Lf5, Lr5 and are capable of restricting the generation of the base hydraulic brake force to less than a predetermined value by admitting the base fluid pressure from the master cylinder 25 until the braking manipulation state is varied from the stepping-in starting state to the predetermined state and are also capable of releasing the restriction on the generation of the base hydraulic brake force by suppressing the admission of the base fluid pressure from the master cylinder 25 after the braking manipulation state advances beyond the predetermined state.

### Sixth Embodiment

In the foregoing fourth embodiment, the base hydraulic brake force generation restricting means is constituted by the master cylinder 25, and the first port 25h which is provided in the first fluid pressure chamber 25r of the master cylinder 25 to communicate with the reservoir tank 28 is provided at the second position which corresponds to the aforementioned predetermined state to be distanced by the predetermined distance (s) from the first position which corresponds to the stepping-in starting state of the closing end of the first piston 25b for closing the first port 25h, in the pressure increasing direction of the first piston 25b. Alternatively, the base hydraulic brake force generation restricting means may be constituted by a connecting member (e.g., the operating rod 126, the push rod 127 or the like) which is provided between the brake-pedal 20 and the first piston 25b of the master cylinder 25 for connecting the both members 20 and 25b together. Description will be made regarding an example wherein the operating rod 126 is employed as the connecting member.

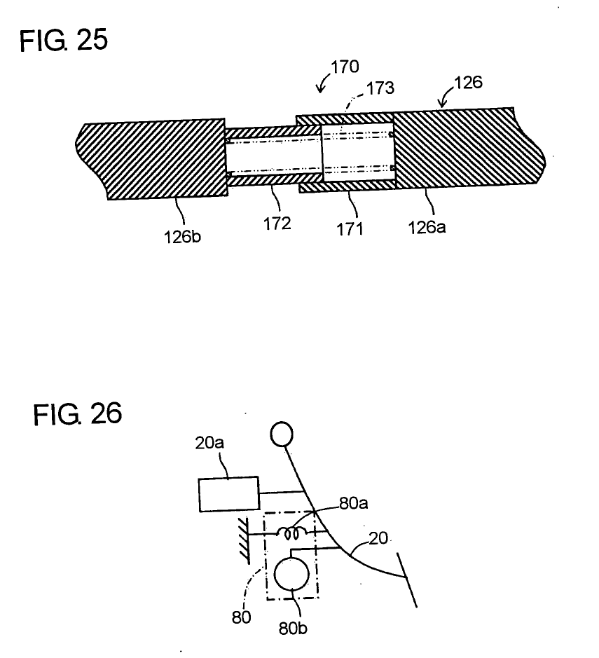

Specifically, as shown in FIG. 25, the operating rod 126 is provided with a manipulation force transmission mechanism 170 which is constructed so that the manipulation force applied to the brake pedal 20 is not transmitted to the first piston 25b of the master cylinder 25 until the braking manipulation state is varied from the stepping-in starting state to the predetermined state, but is transmitted to the first piston 25b of the master cylinder 25 after the braking manipulation state is varied beyond the predetermined state. The manipulation force transmission mechanism 170 is provided at a junction section between a first operating rod 126a and a second operating rod 126b which constitute the operating rod 126. The first operating rod 126a attached to the brake pedal 20 at one end thereof is provided with a cylindrical sleeve 171 at the other end thereof, and the second operating rod 126b is provided at one end thereof with a cylindrical engaging portion 172 which is received in the cylindrical sleeve 171 to slidably reciprocate. A suitable means (not shown in FIG. 25) is provided for preventing the cylindrical engaging portion 172 from coming off from the cylindrical sleeve 171. Further, a spring 173 is received between the cylindrical sleeve 171 and the cylindrical engaging portion 172 for urging the both members in the reciprocation direction. In this case, the master cylinder 25 is constructed to be the same as that used in the fourth and fifth embodiments, and the pressure regulating reservoirs 250f (250r) are constructed to be the same as those used in the fourth embodiment.

The operation of the hydraulic brake device 11 with the connection member as constructed above will be described hereinafter. First of all, when the master cylinder pressure (base fluid pressure) is not generated with the brake pedal 20 being not stepped in and when the controlled fluid pressure is not generated with the brake actuator 48 being not operated, the manipulation force transmission mechanism 170 remains in the state shown in FIG. 25 with the operating rod 126 being stretched by the resilient force of the spring 173 to the maximum length.

When the brake pedal 20 is stepped on, the first operating rod 126a is moved by the manipulation force toward the second operating rod 126b against the resilient force of the spring 173. At this time, since the resilient force of the spring 173 is set to be smaller than those resilient forces of a return spring (not shown) provided in the vacuum booster 27 and the spring 25e of the master cylinder 25 which springs work to return the second operating rod 126b to the home position, the spring 173 is compressed, but the second operating rod 126b is not moved. That is, the generation of the master cylinder pressure in the master cylinder 25 is restricted, so that the master cylinder pressure is not applied to the wheel cylinders 30fl, 30fr, 30rl, 30rr.

When the brake pedal 20 is further stepped in to bring the end of the sleeve portion 171 into contact with the cylindrical engaging portion 172, the second operating rod 126b is then moved by the manipulation force together with the first operating rod 126a. That is, the master cylinder 25 begins to generate the master cylinder pressure therein, and the master cylinder pressure generated by the stepping-in of the brake pedal 20 is applied to the wheel cylinders 30fl, 30fr, 30rl, 30rr. Thereafter, the stepping-in of the brake pedal 20 is released, the manipulation force transmission mechanism 170 is returned by means of the resilient force of the spring 173 to the state shown in FIG. 25.

The base hydraulic brake force which is generated by the hydraulic brake device 11 in dependence on the base fluid pressure has a property curve indicated by the solid line in FIG. 19. Specifically, when the brake pedal stoke is between the stepping-in starting position and the position where the first operating rod 126a comes into abutting engagement with the second operating rod 126b, the base fluid pressure which is generated within the first and second fluid pressure chambers 25r, 25f of the master cylinder 25 is restricted to zero, whereby the generation of the base hydraulic brake force is restricted also to zero. Then, when the brake pedal stroke advances beyond the position where the first operating rod 126a comes into abutting engagement with the second operating rod 126b, the aforementioned restriction on the generation of the base fluid pressure is released, and the base fluid pressure generated in the first and second fluid pressure chambers 25r, 25f becomes that corresponding to the brake pedal stroke, whereby the base hydraulic brake force becomes that corresponding to the brake pedal stroke. It is to be noted that the state where the first operating road 126a is at the position to come into abutting engagement with the second operating rod 126b is the predetermined state and the brake manipulation state wherein the base hydraulic brake force begins to increase in dependence on the brake pedal stroke. Accordingly, by directly applying the base fluid pressure to the wheel cylinders 30fl, 30fr, 30rl, 30rr as indicated by the solid line shown in FIG. 19, it can be realized to make the wheels 23fl, 23fr, 23rl, 23rr generate the base hydraulic brake force corresponding to the base fluid pressure. Also in this sixth embodiment, it can be realized to restrict the generation of the base hydraulic brake force with the simplified construction.

As shown in FIG. 26, a reaction force actuator 80 may be utilized as the pedal reaction force applying means in each of the fifth and sixth embodiments. The reaction force actuator 80 is composed of a spring 80a applying a force (i.e., pedal reaction force) to the brake pedal 20 in a direction opposite to the stepping-in direction and an electric motor 80b driven by the brake ECU 13. With this construction, the pedal reaction force is made to be variable by driving the electric motor 80b in adjusting the pedal reaction force given by the spring 80a. The reaction force actuator 80 is operable to apply the pedal reaction force to the brake pedal 20 in accordance with an arithmetic operation of the brake ECU 13.

Also in each of the fourth to sixth embodiments, the brake conduit system is constructed in a fashion of front and rear separations. However, it may take the conduit construction in an X-letter arrangement fashion.

Also in each of the fourth to sixth embodiments, a larger one of the pedal stroke and the master cylinder pressure may be selected as the braking manipulation state to be used in control when the braking manipulation state is advanced beyond the predetermined state.

Also in each of the fourth to sixth embodiments, the vacuum booster 27 is employed as booster device. In a modified form, the fluid pressure generated by a pump may be accumulated in an accumulator, and the fluid pressure may be applied to a piston thereby to boost the pedal stepping force acting on the brake pedal 20.

Further, the present invention is applicable not only to hybrid cars but also to vehicles which mounts an electric motor only as drive power source and which incorporates a vehicle brake device having a master cylinder with a vacuum booster. In this case, there is required a vacuum source.

Various features and many of the attendant advantages in the foregoing fourth to sixth embodiments will be summarized as follows:

In the vehicle brake device in the foregoing fourth embodiment typically shown in FIGS. 15 to 19, upon the stepping-in of the brake pedal 20, the base hydraulic brake force generation restricting means 25 restricts the generation of the base hydraulic brake force to a predetermined value or less until the braking manipulation state is varied from a stepping-in starting state which is the state at the time point of the stepping-in start to the predetermined state. Thus, when the driver steps on the brake pedal 20, the base hydraulic brake force is compulsorily restricted to the predetermined value or less from the stepping-in starting state until the predetermined state is reached. During this period, on the other hand, the regenerative brake device 12 uses its regenerative brake force to compensate for the lack of the base hydraulic brake force in the vehicle brake force through the cooperative operation with the hydraulic brake device 11 in attaining a vehicle brake force corresponding to the braking manipulation state. Accordingly, in the low stepping force range extending from the stepping-in starting state until the predetermined state is reached, the regenerative brake force is positively utilized, so that it can be realized to achieve a high regeneration efficiency and hence, a high fuel efficiency.

Also in the vehicle brake device in the foregoing fourth embodiment typically shown in FIGS. 15 to 19, after the braking manipulation state becomes the predetermined state, the base hydraulic brake force generation-restricting means 25 releases the restriction on the generation of the base hydraulic brake force, and the regenerative brake device 12 generates its maximum regenerative brake force. Accordingly, by delaying the generation of the base hydraulic brake force as long as possible, it can be realized to utilize the regenerative brake force to the maximum and usefully over the whole range during the stepping-in of the brake pedal 20.

Also in the vehicle brake device in the foregoing fourth embodiment typically shown in FIGS. 16 and 17, the base hydraulic brake force generation restricting means comprises the master cylinder 25 in which the first port 25h provided in the first fluid pressure chamber 25r of the master cylinder 25 and communicating with the reservoir tank 28 is provided at the second position (FIG. 16) which corresponds to the predetermined state to be distanced by a predetermined distance (s) in the pressure increasing direction from the first position (FIG. 17) which corresponds to the stepping-in starting state of the first piston 25b at the closing end where the first piston 25b closes the first port 25h. Thus, it can be realized to restrict the generation of the base hydraulic brake force with the simplified construction.

Also in the vehicle brake device in the foregoing fifth embodiment typically shown in FIGS. 18 and 23, the base hydraulic brake force generation restricting means includes the fluid pressure admitting sections 350f, 350r for restricting the generation of the base hydraulic brake force to the predetermined value or less by admitting the base fluid pressure from the master cylinder 25 until the braking manipulation state changes from the stepping-in starting state to the predetermined state and for releasing the restriction on the generation of the base hydraulic brake force by restricting the admission of the base fluid pressure from the master cylinder 25 after the braking manipulation state changes to the predetermined state. Thus, it can be realized to restrict the generation of the base hydraulic brake force with the simplified construction.

Also in the vehicle brake device in the foregoing fifth embodiment typically shown in FIGS. 18 and 23, the hydraulic brake device 11 is further provided with the pressure regulating reservoirs 350f, 350r storing brake fluid flown from the master cylinder 25 or the wheel cylinders 30 and the pumps 38 for drawing the brake fluid from the wheel cylinders 30 or the brake fluid stored in the pressure regulating reservoir 350f (350r) to discharge the brake fluid to the master cylinder 25 and is constructed to be capable of applying to the wheel cylinders 23 the controlled fluid pressure which is generated by driving the pumps 38 and controlling the solenoid fluid pressure proportional control valves 32, independently of the base fluid pressure generated in dependence on the braking manipulation state so that the controlled hydraulic brake force is generated on the wheels 23 corresponding to the wheel cylinders 30. The fluid pressure admitting sections comprises the pressure regulating reservoirs 350f, 350r each including the ball valve 251a, wherein in the stepping-in starting state, the ball valve 251a constituting a pressure regulating valve of the pressure regulating reservoir 350f, 350r is positioned at the position distanced by the predetermined distance (S0) in the valve opening direction from the valve closing position where the ball valve 251a comes into contact with the valve seat 251b having a valve hole 251b1 to close the valve hole 251b1 and wherein in the predetermined state, the ball valve 251a is positioned at the valve closing position. Thus, it can be realized to restrict the generation of the base hydraulic brake force with the simplified construction.

Also in the vehicle brake device in the foregoing sixth embodiment typically shown in FIGS. 18 and 25, the base hydraulic brake force generation restricting means includes the connection member 126 provided between the brake pedal 20 and the first piston 25b of the master cylinder 25 for connecting the brake pedal 20 and the first piston 25b of the master cylinder 25. The connection member 126 is provided with the manipulation force transmission mechanism 170 for causing the manipulation force applied to the brake pedal 20 not to be transmitted to the first piston 25b until the braking manipulation state changes from the stepping-in starting state to the predetermined state, but causing the manipulation force applied to the brake pedal 20 to be transmitted to the first piston 25b after the predetermined state is reached. Thus, it can be realized to restrict the generation of the base hydraulic brake force with the simplified construction.

Also in the vehicle brake device in the foregoing fourth embodiment typically shown in FIGS. 18 and 20 to 22, the hydraulic brake device 11 is further provided with the pressure regulating reservoirs 250f, 250r storing brake fluid flown from the master cylinder 25 or the wheel cylinders 30 and the pumps 38 for drawing the brake fluid from the wheel cylinders 30 or the brake fluid stored in the pressure regulating reservoirs 250f, 250r to discharge the brake fluid to the master cylinder 25. The hydraulic brake device 11 is constructed to be capable of applying to the wheel cylinders 30 the controlled fluid pressure which is generated by driving the pumps 38 and controlling the solenoid fluid pressure proportional control valves 32, independently of the base fluid pressure generated in dependence on the braking manipulation state so that the controlled hydraulic brake force is generated on the wheel 23 corresponding to the wheel cylinders 30. The hydraulic brake device 11 is further provided with the brake force compensating means (48, step 316) for generating the controlled fluid pressure by driving the pumps 38 and by controlling the solenoid fluid pressure proportional control valves 32 when the variation in the actual regenerative brake force is detected with the generation of the base hydraulic brake force being restricted by the base hydraulic brake force generation restricting means (25, 25h) and for causing the wheels 23 to generate the controlled hydraulic brake force depending on the controlled fluid pressure thereby to compensate for the lack of the regenerative brake force due to the detected variation. Thus, it can be realized to stably apply the brake force demanded by the driver regardless of the variation in the regenerative brake force.

Also in the vehicle brake device in any one of the foregoing fourth to sixth embodiments typically shown in FIG. 18, the braking manipulation state is detected by the brake pedal stroke sensor 20a for detecting the stroke of the brake pedal 20 or by the master cylinder stroke sensor 25z for detecting the stoke of the master cylinder 25. Thus, it can be realized to detect the braking manipulation state reliably and directly by the stroke sensor 20a or 25z.

Also in the vehicle brake device in any one of the foregoing fourth to sixth embodiments typically shown in FIG. 16 or 26, the pedal reaction force applying means 20b or 80 is further provided for applying the reaction force to the brake pedal 20 until the braking manipulation state changes to the predetermined state. Thus, the driver is given a good pedal feeling until the braking manipulation state reaches the predetermined state after the stepping-in of the brake pedal 20.

Obviously, numerous modifications and variations of the present invention are possible in light of the above teachings. It is therefore to be understood that within the scope of the appended claims, the present invention may be practiced otherwise than as specifically described herein.

1. A vehicle brake device comprising:
a hydraulic brake device for generating by a master cylinder a base fluid pressure corresponding to a braking manipulation and for applying the generated base fluid pressure to wheel cylinders of wheels which are connected to the master cylinder through fluid passages having a fluid pressure control valve thereon so that a base hydraulic brake force is generated on the wheels, the hydraulic brake device being provided also for driving a pump to generate and apply a controlled fluid pressure to the wheel cylinders so that a controlled hydraulic brake force is generated on the wheels;
a regenerative brake device for causing any of the wheels to generate a regenerative brake force corresponding to the state of the braking manipulation;
variation detecting means for detecting the variation of an actual regenerative brake force, actually generated by the regenerative braking device, from a target regenerative brake force; and
brake force compensating means for generating the controlled fluid pressure through driving the pump of the hydraulic brake device and through controlling the fluid pressure control valve so that a controlled hydraulic brake force depending on the controlled fluid pressure is generated on the wheels to compensate for the lack of the regenerative brake force due to the variation which is detected by the variation detecting means.

2. A vehicle brake device comprising:
a hydraulic brake device for generating by a master cylinder a base fluid pressure corresponding to a braking manipulation and for applying the generated base fluid pressure to wheel cylinders of wheels which are connected to the master cylinder through fluid passages having a fluid pressure control valve thereon so that a base hydraulic brake force is generated on the wheels, the hydraulic brake device being provided also for driving a pump to generate and apply a controlled fluid pressure to the wheel cylinders so that a controlled hydraulic brake force is generated on the wheels;
a regenerative brake device for causing any of the wheels to generate a regenerative brake force corresponding to the state of the braking manipulation;
variation detecting means for detecting the variation of an actual regenerative brake force, actually generated by the regenerative braking device, from a target regenerative brake force; and
brake force compensating means operable when the variation is detected by the variation detecting means, for generating the controlled fluid pressure through driving the pump of the hydraulic brake device and through controlling the fluid pressure control valve so that a controlled hydraulic brake force depending on the controlled fluid pressure is generated on the wheels to compensate for the lack of the regenerative brake force due to the variation which is detected by the variation detecting means.

3. The vehicle brake device as set forth in claim 1, wherein the hydraulic brake device has a booster device connected to the master cylinder for boosting the brake manipulation and wherein the master cylinder generates the base fluid pressure which corresponds to the force boosted by the booster device.

4. The vehicle brake device as set forth in claim 2, wherein the hydraulic brake device has a booster device connected to the master cylinder for boosting the brake manipulation and wherein the master cylinder generates the base fluid pressure which corresponds to the force boosted by the booster device.

5. The vehicle brake device as set forth in claim 1, wherein the brake force compensating means controls the fluid pressure control valve which is provided in each of front and rear brake systems of the vehicle.

6. The vehicle brake device as set forth in claim 2, wherein the brake force compensating means controls the fluid pressure control valve which is provided in each of front and rear brake systems of the vehicle.

7. The vehicle brake device as set forth in claim 5, further comprising:
front-rear brake force distribution regulating means for regulating a predetermined front-rear brake force distribution for the front and rear brake systems;
brake force detecting means for detecting brake forces generated on the respective wheels in the front and rear brake systems;
front-rear brake force distribution compensating means operable when any of the brake forces detected by the brake force detecting means lacks in terms of the regulated front-rear brake force distribution, for generating the controlled fluid pressure through driving the pump of the hydraulic brake device and through controlling the fluid pressure control valve so that the controlled hydraulic brake force depending on the controlled fluid pressure is generated on the wheels to compensate for the lack in terms of the front-rear brake force distribution.

8. The vehicle brake device as set forth in claim 6, further comprising:
front-rear brake force distribution regulating means for regulating a predetermined front-rear brake force distribution for the front and rear brake-systems;
brake force detecting means for detecting brake forces generated on the respective wheels in the front and rear brake systems;
front-rear brake force distribution compensating means operable when any of the brake forces detected by the brake force detecting means lacks in terms of the regulated front-rear brake force distribution, for generating the controlled fluid pressure through driving the pump of the hydraulic brake device and through controlling the fluid pressure control valve so that the controlled hydraulic brake force depending on the controlled fluid pressure is generated on the wheels to compensate for the lack in terms of the front-rear brake force distribution.

9. A vehicle brake device comprising:
a hydraulic brake device provided in a vehicle having front and rear brake systems, for generating by a master cylinder a base fluid pressure corresponding to a braking manipulation and for applying the generated base fluid pressure to wheel cylinders of wheels which are connected to the master cylinder through fluid passages having a fluid pressure control valve thereon so that a base hydraulic brake force is generated on the wheels, the hydraulic brake device being provided also for driving a pump to generate and apply a controlled fluid pressure to the wheel cylinders so that a controlled brake force is generated on the wheels;
a regenerative brake device for causing any of the wheels to generate a regenerative brake force corresponding to the state of the braking manipulation;
variation detecting means for detecting the variation of an actual regenerative brake force, actually generated by the regenerative brake device, from a target regenerative brake force;
front-rear brake force distribution regulating means for regulating a predetermined front-rear brake force distribution for the front and rear brake systems;
brake force detecting means for detecting brake forces generated on the respective wheels in the front and rear brake systems;
front-rear brake force distribution compensating means operable when the brake forces detected by the brake force detecting means lack in terms of the regulated front-rear brake force distribution, for generating the controlled fluid pressure through driving the pump of the hydraulic brake device and through controlling the fluid pressure control valve so that the controlled hydraulic brake force depending on the controlled fluid pressure is generated on the wheels to compensate for the lack in terms of the front-rear brake force distribution.

10. The vehicle brake device as set forth in claim 9, wherein the front-rear brake force distribution compensating means compensates for the lack in terms of the front-rear brake force distribution when the variation is detected by the variation detecting means.

11. The vehicle brake device as set forth in claim 1, wherein a fluid pressure sensor is arranged downstream of the fluid pressure control valve, and wherein the brake force compensating means controls the fluid pressure control valve based on an output of the fluid pressure sensor.

12. The vehicle brake device as set forth in claim 2, wherein a fluid pressure sensor is arranged downstream of the fluid pressure control valve, and wherein the brake force compensating means controls the fluid pressure control valve based on an output of the fluid pressure sensor.

13. The vehicle brake device as set forth in claim 9, wherein a fluid pressure sensor is arranged downstream of the fluid pressure control valve, and wherein the front-rear brake force distribution compensating means controls the fluid pressure control valve based on an output of the fluid pressure sensor.

14. The vehicle brake device as set forth in claim 11, wherein the fluid pressure control valve is provided for each of plural separate systems, and wherein the fluid pressure sensor is arranged downstream of the fluid pressure control valve provided for each of the separate systems.

15. The vehicle brake device as set forth in claim 12, wherein the fluid pressure control valve is provided for each of plural separate systems, and wherein the fluid pressure sensor is arranged downstream of the fluid pressure control valve provided for each of the separate systems.

16. The vehicle brake device as set forth in claim 13, wherein the fluid pressure control valve is provided for each of plural separate systems, and wherein the fluid pressure sensor is arranged downstream of the fluid pressure control valve provided for each of the separate systems.

17. A vehicle brake control device for controlling a hydraulic brake device, the hydraulic brake device being is provided for generating by a master cylinder a base fluid pressure corresponding to a braking manipulation and for applying the generated base fluid pressure to wheel cylinders of wheels which are connected to the master cylinder through fluid passages having a fluid pressure control valve thereon so that a base hydraulic brake force is generated on the wheels, the hydraulic brake device being provided also for driving a pump to generate and apply a controlled fluid pressure to the wheel cylinders so that a controlled hydraulic brake force is generated on the wheels;
variation detecting means for detecting the variation from a target regenerative brake force of an actual regenerative brake force actually generated by a regenerative brake device which causes any of the wheels to generate a regenerative brake force corresponding to the state of the braking manipulation; and
brake force compensating means operable when the variation is detected by the variation detecting means, for generating the controlled fluid pressure through driving the pump of the hydraulic brake device and through controlling the fluid pressure control valve so that a controlled hydraulic brake force depending on the controlled fluid pressure is generated on the wheels to compensate for the lack of the regenerative brake force due to the variation which is detected by the variation detecting means.

18. The vehicle brake control device as set forth in claim 17, wherein the variation detecting means comprises:
target regenerative brake force calculating means for calculating the target regenerative brake force of the regenerative brake device in dependence on the state of the braking manipulation;
actual regenerative brake force inputting means for inputting the actual regenerative brake force which the regenerative brake device has actually applied to the wheels in response to the target regenerative brake force calculated by the target regenerative brake force calculating means;
difference calculating means for calculating a difference between the target regenerative brake force calculated by the target regenerative brake force calculating means and the actual regenerative brake force input by the actual regenerative brake force inputting means; and
judgment means for detecting the occurrence of the variation of the regenerative brake force if the difference calculated by the difference calculating means is larger than a predetermined value.

19. The vehicle brake control device as set forth in claim 17, wherein brake force compensating means comprises:
target regenerative brake force calculating means for calculating the target regenerative brake force of the regenerative brake device in dependence on the state of the braking manipulation;
actual regenerative brake force inputting means for inputting the actual regenerative brake force which the regenerative brake device has actually applied to the wheels in response to the target regenerative brake force calculated by the target regenerative brake force calculating means;
difference calculating means for calculating a difference between the target regenerative brake force calculated by the target regenerative brake force calculating means and the actual regenerative brake force input by the actual regenerative brake force inputting means; and
control means for generating the controlled fluid pressure so that the controlled hydraulic brake force is generated to correspond to the difference calculated by the difference calculating means.

20. A vehicle brake device comprising:
a hydraulic brake device for boosting a braking manipulation force of the driver by a booster device in a predetermined boosting ratio, for generating a base fluid pressure corresponding to the boosted braking manipulation force by a master cylinder connected to the booster device so that the generated base fluid pressure is applied to wheel cylinders of wheels which are connected to the master cylinder through passages having a fluid pressure control valve thereon to make the wheels generate a base hydraulic brake force, the hydraulic brake device being also provided for driving a pump to generate and apply a controlled fluid pressure to the wheel cylinders so that a controlled hydraulic brake force is generated on the wheels associated with the wheel cylinders;
a regenerative brake device for causing any of the wheels to generate a predetermined regenerative brake force when having the braking manipulation force input thereto so that the predetermined regenerative brake force together with the base hydraulic brake force makes a target brake force corresponding to the braking manipulation force;
variation detecting means for detecting the variation of an actual regenerative brake force actually generated by the regenerative brake device, from the predetermined regenerative brake force; and
brake force compensating means operable when the variation is detected by the variation detecting means, for generating the controlled fluid pressure through driving the pump of the hydraulic brake device and through controlling the fluid pressure control valve so that the controlled hydraulic brake force depending on the controlled fluid pressure is generated on the wheels to compensate for the lack of the regenerative brake force due to the detected variation;
wherein the booster device has a boosting property that the boosting ratio is low when the braking manipulation force is in a low range but becomes high when the braking manipulation force exceeds the low range.

21. The vehicle brake device as set forth in claim 20, wherein the boosting property is determined so that an approximately straight line regulating the boosting ratio in the low range is bent in a direction to become high when the low range is exceeded.

22. The vehicle brake device as set forth in claim 21, wherein a position at which the approximately straight line is bent is determined in dependence on the capability of the regenerative brake device in generating the regenerative brake force.

23. A vehicle brake device comprising:
a hydraulic brake device for boosting a braking manipulation force of the driver by a booster device in a predetermined boosting ratio, for generating a base fluid pressure corresponding to the boosted braking manipulation force by a master cylinder connected to the booster device so that the generated base fluid pressure is applied to wheel cylinders of wheels which are connected to the master cylinder through passages having a fluid pressure control valve thereon to make the wheels generate a base hydraulic brake force, the hydraulic brake device being also provided for driving a pump to generate and apply a controlled fluid pressure to the wheel cylinders so that a controlled hydraulic brake force is generated on wheels associated with the wheel cylinders;
a regenerative brake device for causing any of the wheels to generate a predetermined regenerative brake force when having the braking manipulation force input thereto so that the predetermined regenerative brake force together with the base hydraulic brake force makes a target brake force corresponding to the braking manipulation force;
variation detecting means for detecting the variation of an actual regenerative brake force actually generated by the regenerative brake device, from the predetermined regenerative brake force; and
brake force compensating means operable when the variation is detected by the variation detecting means, for generating the controlled fluid pressure through driving the pump of the hydraulic brake device and through controlling the fluid pressure control valve so that the controlled hydraulic brake force depending on the controlled fluid pressure is generated on the wheels to compensate for the lack of the regenerative brake force due to the detected variation;
wherein the booster device upon the braking manipulation force input thereto boosts the braking manipulation force in accordance with a first boosting property that the boosting ratio is low when the stepping speed of a brake pedal is average and boosts the braking manipulation force in accordance with a second boosting property that the boosting ratio is high when the stepping speed of the brake pedal is fast.

24. The vehicle brake device as set forth in claim 23, wherein the first boosting property is such that the boosting ratio is low when the braking manipulation force is in the low range but becomes high when the low range is exceeded.

25. The vehicle brake device as set forth in claim 24, wherein the first boosting property is determined so that an approximately straight line regulating the boosting ratio in the low range is bent in a direction to become high when the low range is exceeded.

26. The vehicle brake device as set forth in claim 25, wherein a position at which the approximately straight line is bent is determined in dependence on the capability of the regenerative brake device in generating the regenerative brake force.

27. A vehicle brake device comprising:
a hydraulic brake device for generating by a master cylinder a base fluid pressure corresponding to a braking manipulation state that a brake pedal is stepped in and for applying the generated base fluid pressure directly to wheel cylinders of wheels which are connected to the master cylinder through fluid passages having a fluid pressure control valve thereon so that a base hydraulic brake force corresponding to the base fluid pressure is generated on the wheels; and
a regenerative brake device for causing any of the wheels to generate a regenerative brake force corresponding to the braking manipulation state;
wherein the vehicle brake device is capable of cooperatively operating the hydraulic brake device and the regeneration bake device for applying to the vehicle a vehicle brake force corresponding to the braking manipulation state based on the base hydraulic brake force and the regenerative brake force, and
wherein the vehicle brake device further comprises base hydraulic brake force generation restricting means for restricting the generation of the base hydraulic brake force to a predetermined value or less until the braking manipulation state is varied from a stepping-in starting state which is the state at a time point of stepping-in start to a predetermined state.

28. The vehicle brake device as set forth in claim 27, wherein after the braking manipulation state becomes the predetermined state, the base hydraulic brake force generation restricting means releases the restriction on the generation of the base hydraulic brake force and the regenerative brake device generates its maximum regenerative brake force.

29. The vehicle brake device as set forth in claim 27, wherein the base hydraulic brake force generation restricting means is constituted by the master cylinder, in which a port provided in a fluid pressure chamber of the master cylinder and communicating with a reservoir tank is provided at a second position which corresponds to the predetermined state to be distanced by a predetermined distance in a pressure increasing direction from a first position which corresponds to the stepping-in starting state of a piston at a closing end where the piston closes the port.

30. The vehicle brake device as set forth in claim 27, wherein the base hydraulic brake force generation restricting means is constituted by a fluid pressure admitting section for restricting the generation of the base hydraulic brake force to the predetermined value or less by admitting the base fluid pressure from the master cylinder until the braking manipulation state changes from the stepping-in starting state to the predetermined state and for releasing the restriction on the generation of the base hydraulic brake force by restricting the admission of the base fluid pressure from the master cylinder after the braking manipulation state changes to the predetermined state.

31. The vehicle brake device as set forth in claim 30, wherein:
the hydraulic brake device is further provided with a pressure regulating reservoir for storing brake fluid flown from the master cylinder or the wheel cylinders and a pump for drawing the brake fluid from the wheel cylinders or the brake fluid stored in the pressure regulating reservoir to discharge the brake fluid to the master cylinder;
the hydraulic brake device is constructed to be capable of applying to the wheel cylinders a controlled fluid pressure which is generated by driving the pump and controlling the fluid pressure control valve, independently of the base fluid pressure generated in dependence on the braking manipulation state so that a controlled hydraulic brake force is generated on the wheels corresponding to the wheel cylinders; and
the fluid pressure admitting section comprises the pressure regulating reservoir which includes a ball valve constituting a pressure regulating valve of the pressure regulating reservoir, wherein in the stepping-in starting state, the ball valve is positioned at a position separated by a predetermined distance in a valve opening direction from a valve closing position where the ball valve comes into contact with a valve seat having a valve hole to close the valve hole and wherein in the predetermined state, the ball valve is positioned at the valve closing position.

32. The vehicle brake device as set forth in claim 27, wherein:
the base hydraulic brake force generation restricting means is constituted by a connection member provided between the brake pedal and a piston of the master cylinder for connecting the brake pedal and the piston of the master cylinder; and
the connection member is provided with a manipulation force transmission mechanism for causing a manipulation force applied to the brake pedal not to be transmitted to the piston until the braking manipulation state changes from the stepping-in starting state to the predetermined state, but causing the manipulation force applied to the brake pedal to be transmitted to the piston after the predetermined state.

33. The vehicle brake device as set forth in claim 27, wherein:
the hydraulic brake device is further provided with a pressure regulating reservoir for storing brake fluid flown from the master cylinder or the wheel cylinders and a pump for drawing the brake fluid from the wheel cylinders or the brake fluid stored in the pressure regulating reservoir to discharge the brake fluid to the master cylinder;
the hydraulic brake device is constructed to be capable of applying to the wheel cylinders a controlled fluid pressure which is generated by driving the pump and by controlling the fluid pressure control valve, independently of the base fluid pressure generated in dependence on the braking manipulation state so that a controlled hydraulic brake force is generated on the wheels corresponding to the wheel cylinders; and
the hydraulic brake device is further provided with brake force compensating means for generating the controlled fluid pressure by driving the pump and by controlling the fluid pressure control valve when the variation in an actual regenerative brake force is detected with the generation of the base hydraulic brake force being restricted by the base hydraulic brake force generation restricting means and for causing the wheels to generate a controlled hydraulic brake force depending on the controlled fluid pressure thereby to compensate for the lack of the regenerative brake force due to the detected variation.

34. The vehicle brake device as set forth in claim 27, wherein the braking manipulation state is detected by a brake pedal stroke sensor for detecting the stroke of the brake pedal or by a master cylinder stroke sensor for detecting the stoke of the master cylinder.

35. The vehicle brake device as set forth in claim 27, further comprising a pedal reaction force applying means for applying a pedal reaction force to the brake pedal until the braking manipulation state changes to the predetermined state.
